(19) United States
(12) Patent Application Publication
(10) Pub. No.: US 2026/0304435 A1
(43) Pub. Date: Oct. 1, 2026

(54) DOWNLINK CHANNEL MONITORING WITH ON-DEMAND SYNCHRONIZATION SIGNAL PHYSICAL BROADCAST CHANNEL BLOCK TRANSMISSION

(71) Applicant: QUALCOMM Incorporated, San Diego, CA (US)

(72) Inventor: Hung Dinh LY, San Diego, CA (US)

(21) Appl. No.: 19/575,498

(22) Filed: Mar. 23, 2026

Related U.S. Application Data
(60) Provisional application No. 63/779,136, filed on Mar. 27, 2025.

(51) Int. Cl. H04W 72/23; H04W 72/1273

(52) U.S. Cl. CPC H04W 72/23; H04W 72/1273

(57) ABSTRACT

Various aspects of the present disclosure generally relate to wireless communication. Various aspects relate generally to downlink channel monitoring with on-demand synchronization signal block (OD-SSB) transmission. Some aspects more specifically relate to a user equipment (UE) identifying a collision between an OD-SSB transmission and a physical downlink control channel (PDCCH) monitoring occasion and forgoing monitoring for a PDCCH candidate in the PDCCH monitoring occasion. In some aspects, the UE may monitor a PDCCH communication scheduling a PDSCH and may identify a collision between the PDSCH and an OD-SSB transmission. In some aspects, when there is a collision between the PDSCH and an OD-SSB, the UE may selectively receive the PDSCH in accordance with a collision rule and a set of configuration messages, as described in more details herein.

### CROSS-REFERENCE TO RELATED APPLICATION

This Patent Application claims priority to U.S. Provisional Patent Application No. 63/779,136, filed on Mar. 27, 2025, entitled “DOWNLINK CHANNEL MONITORING WITH ON-DEMAND SYNCHRONIZATION SIGNAL PHYSICAL BROADCAST CHANNEL BLOCK TRANSMISSION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with downlink channel monitoring with on-demand synchronization signal / physical broadcast channel block (SSB) transmission.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A synchronization signal / physical broadcast channel block (SSB), which is sometimes referred to as a “synchronization signal block,” is a communication that is associated with providing detection and synchronization information. For example, a network node may transmit an SSB to a user equipment (UE), and the UE may receive the SSB, which may cause the UE to detect and synchronize with a cell being provided by the network node. The SSB may include a primary synchronization signal (PSS) and a secondary synchronization signal (SSS) to provide time and frequency synchronization information to the UE. The SSB may include beam information, which the UE may use to select a beam for a random access channel (RACH) procedure that is used to obtain initial access to a cell. A network node may transmit on-demand SSBs (OD-SSBs) as a response to a triggering event, rather than at a fixed interval, which may provide power savings, improved spectral efficiency, reduced SSB latency, or interference reduction in a cell.

When connected to a cell or as part of a connection procedure with a cell, a UE may receive, from a network node, configuration information identifying a control resource set (CORESET) and a set of search spaces. The UE may monitor a physical downlink control channel (PDCCH) candidate in a search space of the set of search spaces. The PDCCH candidate may convey control information, such as downlink control information (DCI). For example, a network node may transmit a PDCCH communication to schedule a physical downlink shared channel (PDSCH). Additionally, or alternatively, the network node may transmit another type of PDCCH that does not convey DCI associated with a PDSCH, such as group-common PDCCH (for example, DCI format 2_7 or 2_9) or UE-specific PDCCH (for example, PDCCH with a type-3 hybrid automatic repeat request (HARQ) acknowledgment (ACK) codebook). A network node may transmit a PDSCH communication, in resources identified by some PDCCH communications, to convey data to a UE.

### SUMMARY

Some aspects described herein relate to a method of wireless communication performed at a user equipment (UE). The method may include receiving first configuration information identifying a configuration for a set of candidate synchronization signal / physical broadcast channel block (SSBs) associated with a first set of resource elements (REs). The method may include receiving second configuration information identifying a second set of REs for a set of physical downlink control channel (PDCCH) candidates. The method may include receiving third configuration information identifying one or more SSBs, of the set of candidate SSBs, that are transmitted in the first set of REs. The method may include selectively monitoring a PDCCH candidate, of the set of PDCCH candidates, in accordance with the first configuration information, second configuration information, and third configuration information.

Some aspects described herein relate to a method of wireless communication performed at a UE. The method may include receiving first configuration information identifying a configuration for a set of candidate SSBs associated with a first set of REs. The method may include receiving a PDCCH associated with scheduling a physical downlink shared channel (PDSCH) in a second set of REs, where at least one first RE, of the first set of REs, overlaps with at least one second RE, of the second set of REs, corresponding to a PDCCH candidate of the set of PDCCH candidates. The method may include selectively receiving the PDSCH in the at least one second RE in connection with a collision rule for the overlap between the at least one first RE and the at least one second RE.

Some aspects described herein relate to a method of wireless communication performed by a network node. The method may include transmitting first configuration information identifying a configuration for a set of candidate SSBs associated with a first set of REs. The method may include transmitting second configuration information identifying a second set of REs for a set of PDCCH candidates. The method may include transmitting third configuration information identifying one or more SSBs, of the set of candidate SSBs, that are transmitted in the first set of REs. The method may include selectively transmitting a PDCCH candidate, of the set of PDCCH candidates, in accordance with the first configuration information, second configuration information, and third configuration information.

Some aspects described herein relate to a method of wireless communication performed by a network node. The method may include transmitting first configuration information identifying a configuration for a set of candidate SSBs associated with a first set of REs. The method may include transmitting a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The method may include selectively transmitting the PDSCH in the at least one second RE in connection with a collision rule for the overlap between the at least one first RE and the at least one second RE.

Some aspects described herein relate to a UE. The UE may include one or more antennas. The UE may include a processing system. The processing system may include one or more processors and one or more code-storing memories coupled with the one or more processors. The processing system may be configured to cause the UE to wirelessly receive first configuration information identifying a configuration for a set of candidate SSBs associated with a first set of REs. The processing system may be configured to cause the UE to wirelessly receive second configuration information identifying a second set of REs for a set of PDCCH candidates. The processing system may be configured to cause the UE to wirelessly receive third configuration information identifying one or more SSBs, of the set of candidate SSBs, that are transmitted in the first set of REs. The processing system may be configured to cause the UE to selectively monitor, via a wireless link, a PDCCH candidate, of the set of PDCCH candidates, in accordance with the first configuration information, second configuration information, and third configuration information.

Some aspects described herein relate to a UE. The UE may include one or more antennas. The UE may include a processing system. The processing system may include one or more processors and one or more code-storing memories coupled with the one or more processors. The processing system may be configured to cause the UE to wirelessly receive first configuration information identifying a configuration for a set of candidate SSBs associated with a first set of REs. The processing system may be configured to cause the UE to monitor, via a wireless link, a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The processing system may be configured to cause the UE to selectively wirelessly receive the PDSCH in the at least one second RE in connection with a collision rule for the overlap between the at least one first RE and the at least one second RE.

Some aspects described herein relate to a network node. The network node may include one or more antennas. The network node may include a processing system. The processing system may include one or more processors and one or more code-storing memories coupled with the one or more processors. The processing system may be configured to cause the network node to wirelessly transmit first configuration information identifying a configuration for a set of candidate SSBs associated with a first set of REs. The processing system may be configured to cause the network node to wirelessly transmit second configuration information identifying a second set of REs for a set of PDCCH candidates. The processing system may be configured to cause the network node to wirelessly transmit third configuration information identifying one or more SSBs, of the set of candidate SSBs, that are transmitted in the first set of REs. The processing system may be configured to cause the network node to selectively wirelessly transmit a PDCCH candidate, of the set of PDCCH candidates, in accordance with the first configuration information, second configuration information, and third configuration information.

Some aspects described herein relate to a network node. The network node may include one or more antennas. The network node may include a processing system. The processing system may include one or more processors and one or more code-storing memories coupled with the one or more processors. The processing system may be configured to cause the network node to wirelessly transmit first configuration information identifying a configuration for a set of candidate SSBs associated with a first set of REs. The processing system may be configured to cause the network node to wirelessly transmit a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The processing system may be configured to cause the network node to selectively wirelessly transmit the PDSCH in the at least one second RE in connection with a collision rule for the overlap between the at least one first RE and the at least one second RE.

Some aspects described herein relate to a non-transitory computer-readable medium that stores a set of instructions for wireless communication by a UE. The set of instructions, when executed by one or more processors of the UE, may cause the UE to receive first configuration information identifying a configuration for a set of candidate SSBs associated with a first set of REs. The set of instructions, when executed by one or more processors of the UE, may cause the UE to receive second configuration information identifying a second set of REs for a set of PDCCH candidates. The set of instructions, when executed by one or more processors of the UE, may cause the UE to receive third configuration information identifying one or more SSBs, of the set of candidate SSBs, that are transmitted in the first set of REs. The set of instructions, when executed by one or more processors of the UE, may cause the UE to selectively monitor a PDCCH candidate, of the set of PDCCH candidates, in accordance with the first configuration information, second configuration information, and third configuration information.

Some aspects described herein relate to a non-transitory computer-readable medium that stores a set of instructions for wireless communication by a UE. The set of instructions, when executed by one or more processors of a UE, may cause the UE to receive first configuration information identifying a configuration for a set of candidate SSBs associated with a first set of REs. The set of instructions, when executed by one or more processors of a UE, may cause the UE to monitor a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The set of instructions, when executed by one or more processors of a UE, may cause the UE to selectively receive the PDSCH in the at least one second RE in connection with a collision rule for the overlap between the at least one first RE and the at least one second RE.

Some aspects described herein relate to a non-transitory computer-readable medium that stores a set of instructions for wireless communication by a network node. The set of instructions, when executed by one or more processors of the network node, may cause the network node to transmit first configuration information identifying a configuration for a set of candidate SSBs associated with a first set of REs. The set of instructions, when executed by one or more processors of the network node, may cause the network node to transmit second configuration information identifying a second set of REs for a set of PDCCH candidates. The set of instructions, when executed by one or more processors of the network node, may cause the network node to transmit third configuration information identifying one or more SSBs, of the set of candidate SSBs, that are transmitted in the first set of REs. The set of instructions, when executed by one or more processors of the network node, may cause the network node to selectively transmit a PDCCH candidate, of the set of PDCCH candidates, in accordance with the first configuration information, second configuration information, and third configuration information.

Some aspects described herein relate to a non-transitory computer-readable medium that stores a set of instructions for wireless communication by a network node. The set of instructions, when executed by one or more processors of the network node, may cause the network node to transmit first configuration information identifying a configuration for a set of candidate SSBs associated with a first set of REs. The set of instructions, when executed by one or more processors of the network node, may cause the network node to transmit a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The set of instructions, when executed by one or more processors of the network node, may cause the network node to selectively transmit the PDSCH in the at least one second RE in connection with a collision rule for the overlap between the at least one first RE and the at least one second RE.

Some aspects described herein relate to an apparatus for wireless communication. The apparatus may include means for receiving first configuration information identifying a configuration for a set of candidate SSBs associated with a first set of REs. The apparatus may include means for receiving second configuration information identifying a second set of REs for a set of PDCCH candidates. The apparatus may include means for receiving third configuration information identifying one or more SSBs, of the set of candidate SSBs, that are transmitted in the first set of REs. The apparatus may include means for selectively monitoring a PDCCH candidate, of the set of PDCCH candidates, in accordance with the first configuration information, second configuration information, and third configuration information.

Some aspects described herein relate to an apparatus for wireless communication. The apparatus may include means for receiving first configuration information identifying a configuration for a set of candidate SSBs associated with a first set of REs. The apparatus may include means for receiving a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The apparatus may include means for selectively receiving the PDSCH in the at least one second RE in connection with a collision rule for the overlap between the at least one first RE and the at least one second RE.

Some aspects described herein relate to an apparatus for wireless communication. The apparatus may include means for transmitting first configuration information identifying a configuration for a set of candidate SSBs associated with a first set of REs. The apparatus may include means for transmitting second configuration information identifying a second set of REs for a set of PDCCH candidates. The apparatus may include means for transmitting third configuration information identifying one or more SSBs, of the set of candidate SSBs, that are transmitted in the first set of REs. The apparatus may include means for selectively transmitting a PDCCH candidate, of the set of PDCCH candidates, in accordance with the first configuration information, second configuration information, and third configuration information.

Some aspects described herein relate to an apparatus for wireless communication. The apparatus may include means for transmitting first configuration information identifying a configuration for a set of candidate SSBs associated with a first set of REs. The apparatus may include means for transmitting a PDCCH associated with scheduling a PDSCH in a second set of REs, where at least one first RE, of the first set of REs, overlaps with at least one second RE, of the second set of REs, corresponding to a PDCCH candidate of the set of PDCCH candidates. The apparatus may include means for selectively transmitting the PDSCH in the at least one second RE in connection with a collision rule for the overlap between the at least one first RE and the at least one second RE.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a synchronization signal (SS) hierarchy.

FIGS. 3A-3C are diagrams illustrating examples of synchronization signal / physical broadcast channel block (SSB) communications.

FIGS. 4A and 4B are diagrams illustrating an example associated with physical downlink channel (PDCCH) monitoring with on-demand SSB (OD-SSB) transmission.

FIG. 5 is a diagram illustrating an example associated with physical downlink shared channel (PDSCH) reception with OD-SSB transmission.

FIG. 6 is a flowchart illustrating an example process performed, for example, at a user equipment (UE) or an apparatus of a UE that supports downlink channel monitoring with OD-SSB transmission.

FIG. 7 is a flowchart illustrating an example process performed, for example, at a UE or an apparatus of a UE that supports downlink monitoring with OD-SSB transmission.

FIG. 8 is a flowchart illustrating an example process performed, for example, at a network node or an apparatus of a network node that supports downlink channel monitoring with OD-SSB transmission.

FIG. 9 is a flowchart illustrating an example process performed, for example, at a network node or an apparatus of a network node that supports downlink channel monitoring with OD-SSB transmission.

FIG. 10 is a diagram of an example apparatus for wireless communication that supports downlink channel monitoring with OD-SSB transmission.

FIG. 11 is a diagram of an example apparatus for wireless communication that supports downlink channel communication with OD-SSB transmission.

FIGS. 12A-12B are diagrams illustrating examples of examples of SSB burst communications.

### DETAILED DESCRIPTION

A network node may use transmission of synchronization signal / physical broadcast channel block (SSBs), which may be referred to as “synchronization signal blocks,” to provide timing and cell acquisition information to a user equipment (UE). On-demand SSB (OD-SSB) transmission can be configured in a cell to provide for event-triggered SSB transmission, which may improve spectral efficiency, reduce a latency associated with acquiring cell information, reduce power consumption, or reduce interference, among other examples. For example, a network node may transmit an OD-SSB as a response to a UE request, in connection with a UE paging operation or a UE mobility operation, or in connection with a network or device characteristic, such as a network load or power resource level. Both OD-SSBs and always-on SSBs (AO-SSBs) may include a primary synchronization signal (PSS), a secondary synchronization signal (SSS), or a physical broadcast channel (PBCH) payload, among other examples, but may differ with respect to being event-triggered and adaptable in an example of OD-SSBs or periodic in an example of AO-SSBs. A network node may transmit configuration information that identifies a set of parameters for OD-SSB transmission (od-ssb-config), such as a parameter identifying an OD-SSB absolute frequency (od-ssb-absoluteFrequency), an OD-SSB periodicity (od-ssb-Periodicity), an SSB position within an OD-SSB burst (od-ssb-PositionsInBurst), or an OD-SSB physical cell identifier (od-ssb-physCellId), among other examples.

The network node may configure time domain positions of an OD-SSB burst. For example, the network node may configure a system frame number (SFN) offset or a half frame index for an OD-SSB burst with a time domain of possible OD-SSB burst positions. A network node may transmit configuration information, such as a medium access control (MAC) control element (MAC-CE) based OD-SSB transmission indication among other examples, that indicates an SSB that is to be transmitted and provides a periodicity of an OD-SSB. Further, the network node may transmit configuration information, such as MAC-CE signaling among other examples, identifying an SSB burst periodicity adaptation for a non-cell-defining SSB in a secondary cell (Scell or SCell).

When a UE is configured with a control resource set (CORESET) and a set of search spaces, the UE may monitor a search space to receive a physical downlink control channel (PDCCH) candidate in a cell. The UE may monitor the search space, periodically, in a set of resource elements indicated to the UE and corresponding to a set of PDCCH monitoring occasions. However, when a network node can configure OD-SSBs, activate some configured OD-SSBs for transmission and cancel transmission of other OD-SSBs, or adapt an SSB burst periodicity of a set of OD-SSBs, a resource element in which the UE is to monitor the search space may overlap with a resource element in which an OD-SSB is to be transmitted.

In such a scenario, a collision may occur between a first configuration of the UE for receiving an OD-SSB and a second configuration of the UE for monitoring the search space for a PDCCH candidate. For example, receiving the OD-SSB and monitoring the search space may be associated with use of different frequencies, beam directions, or other parameters. Accordingly, the network node and the UE may lose synchronization or experience a dropped communication as a result of the network node expecting the UE to receive one of the communications and the UE actually receiving the other of the communications. Similarly, if the UE receives a PDCCH communication scheduling a physical downlink shared channel (PDSCH) in a resource element, the resource element for the PDSCH may overlap with a resource element of an OD-SSB, which may result in a loss of synchronization between the UE and the network node or a dropped communication.

Various aspects relate generally to downlink channel monitoring with OD-SSB transmission. Some aspects more specifically relate to a UE identifying a collision between an OD-SSB transmission and a PDCCH monitoring occasion and forgoing monitoring for a PDCCH candidate in the PDCCH monitoring occasion. In some aspects, the UE may monitor a PDCCH communication scheduling a PDSCH and may identify a collision between the PDSCH and an OD-SSB transmission. In some aspects, when there is a collision between the PDSCH and an OD-SSB, the UE may selectively receive the PDSCH in accordance with a collision rule and a set of configuration messages, as described in more details herein. As an example of a collision rule, when resource elements (REs) of a first transmission (for example, the OD-SSB transmission) overlap with REs of a second transmission (for example, a transmission that is to occur in a PDCCH monitoring occasion), the overlapping REs are not available for one of the communication operations (for example, for reception of the transmission in the PDCCH monitoring occasion).

Particular aspects of the subject matter described in this disclosure can be implemented to realize one or more of the following potential advantages. In some examples, the described techniques can be used to enable OD-SSB transmission without a loss of synchronization or unexpectedly dropped communications. By enabling OD-SSB transmission, the described techniques can reduce power consumption, improve spectral efficiency, reduce SSB latency, or reduce interference. For example, the described techniques can be used by a UE to selectively monitor a PDCCH candidate (and for a network node to selectively transmit a PDCCH candidate) to configure, for the UE, control information when OD-SSB transmissions are occurring, with a reduced likelihood of interference or dropped communications. Additionally, or alternatively, the described techniques can be used by a UE to selectively receive a PDSCH communication (and for a network node to transmit the PDSCH communication) to obtain data transmission, with a reduced likelihood of interference or dropped communications. Additionally, or alternatively, the described techniques can be used to cause a UE to forgo monitoring a PDCCH candidate or receiving a PDSCH. In this example, the described techniques can be used to prioritize an OD-SSB transmission to a UE, thereby enabling reduced power consumption, improved spectral efficiency, reduced SSB latency, or reduced interference for SSBs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

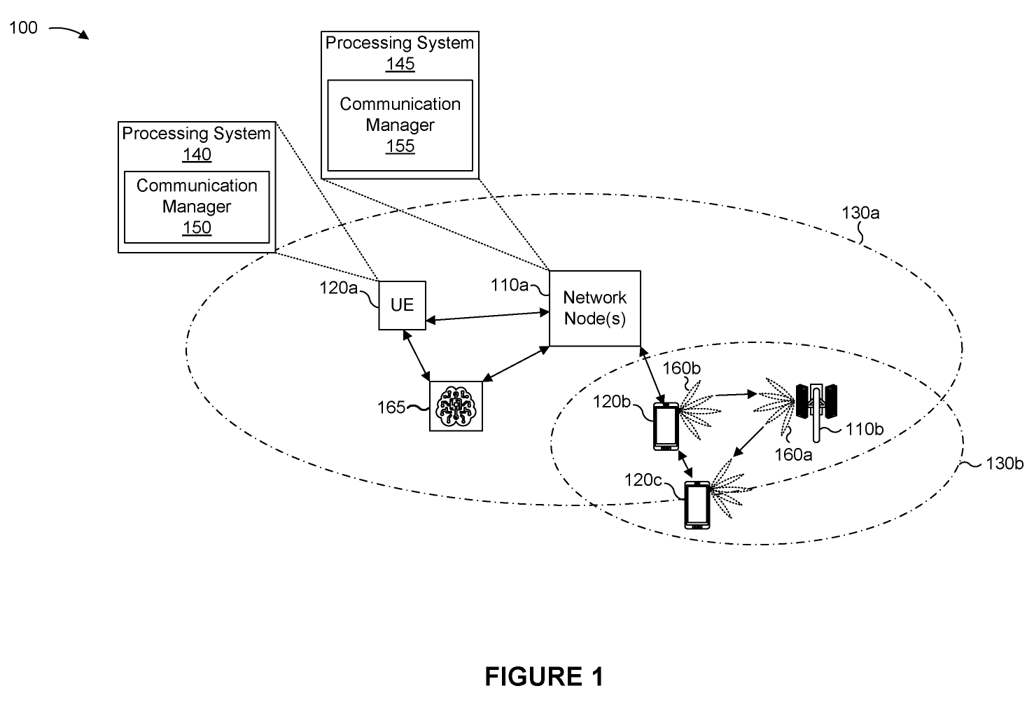

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive first configuration information identifying a configuration for a set of candidate SSBs associated with a first set of REs; receive second configuration information identifying a second set of REs for a set of PDCCH candidates; receive third configuration information identifying one or more SSBs, of the set of candidate SSBs, that are transmitted in the first set of REs; and selectively monitor a PDCCH candidate, of the set of PDCCH candidates, in accordance with the first configuration information, second configuration information, and third configuration information. In some aspects, the communication manager 150 may receive first configuration information identifying a configuration for a set of candidate SSBs associated with a first set of REs; monitor a PDCCH candidate for a PDCCH communication associated with scheduling a PDSCH in a second set of REs, wherein at least one first RE, of the first set of REs, overlaps with at least one second RE, of the second set of REs, corresponding to a PDCCH candidate of the set of PDCCH candidates; and selectively receive the PDSCH in the at least one second RE in connection with a collision rule for the overlap between the at least one first RE and the at least one second RE. Additionally or alternatively, the communication manager 150 may perform one or more other operations described herein.

In some aspects, the network node 110 may include a communication manager 155. As described in more detail elsewhere herein, the communication manager 155 may transmit first configuration information identifying a configuration for a set of candidate SSBs associated with a first set of REs; transmit second configuration information identifying a second set of REs for a set of PDCCH candidates; transmit third configuration information identifying one or more SSBs, of the set of candidate SSBs, that are transmitted in the first set of REs; and selectively transmit a PDCCH candidate, of the set of PDCCH candidates, in accordance with the first configuration information, second configuration information, and third configuration information. In some aspects, the communication manager 155 may transmit first configuration information identifying a configuration for a set of candidate SSBs associated with a first set of REs; transmit a PDCCH associated with scheduling a PDSCH in a second set of REs, wherein at least one first RE, of the first set of REs, overlaps with at least one second RE, of the second set of REs, corresponding to a PDCCH candidate of the set of PDCCH candidates; and selectively transmit the PDSCH in the at least one second RE in connection with a collision rule for the overlap between the at least one first RE and the at least one second RE. Additionally or alternatively, the communication manager 155 may perform one or more other operations described herein.

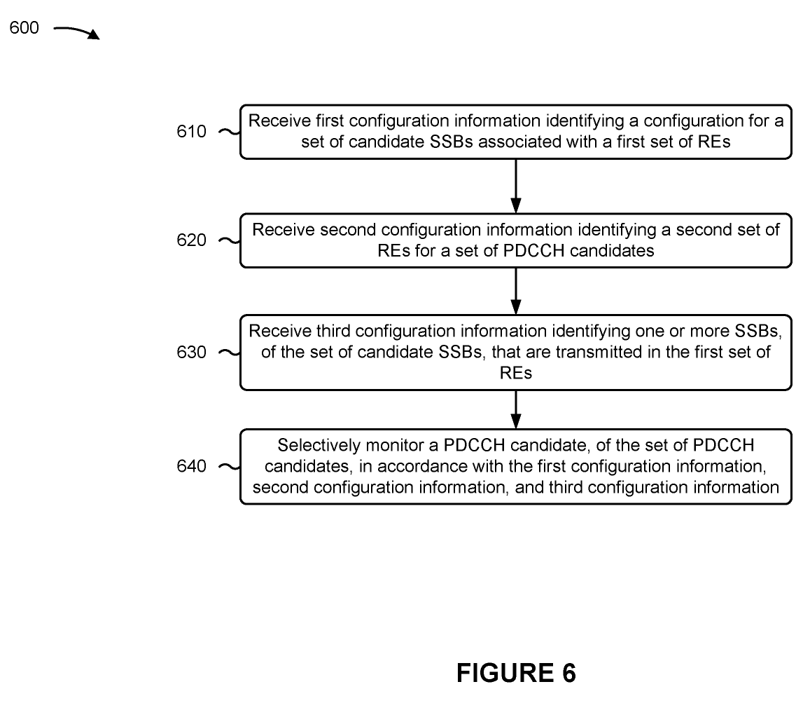

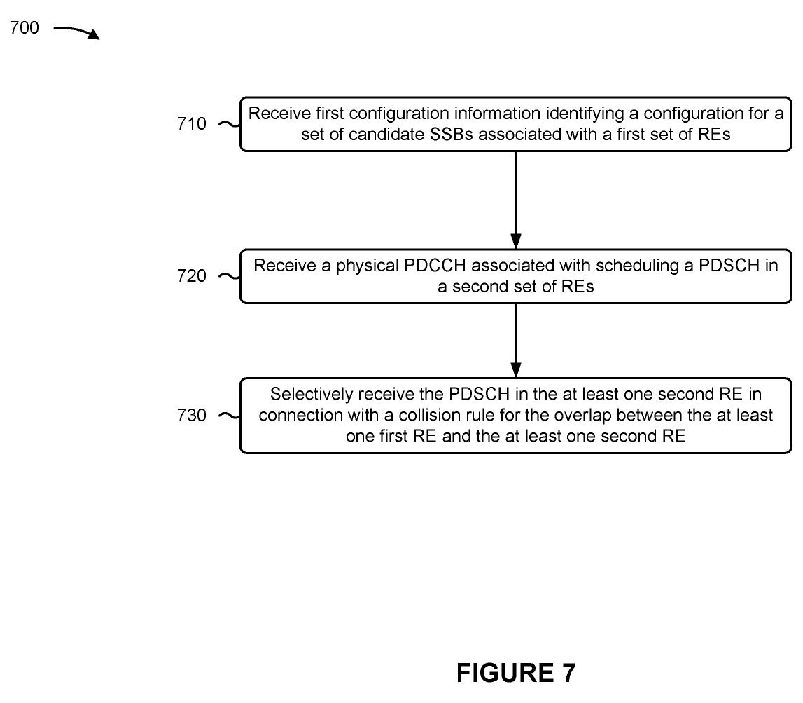

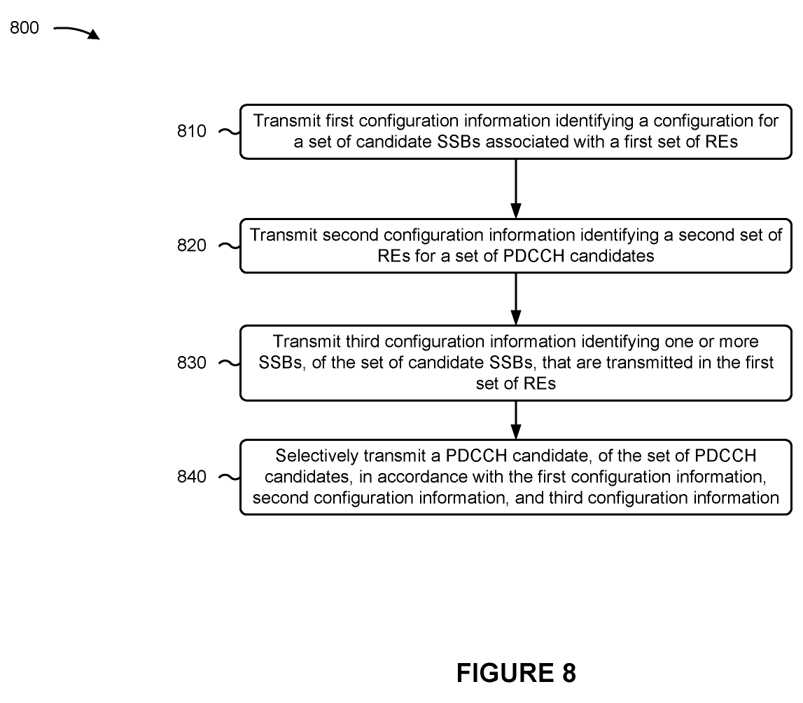

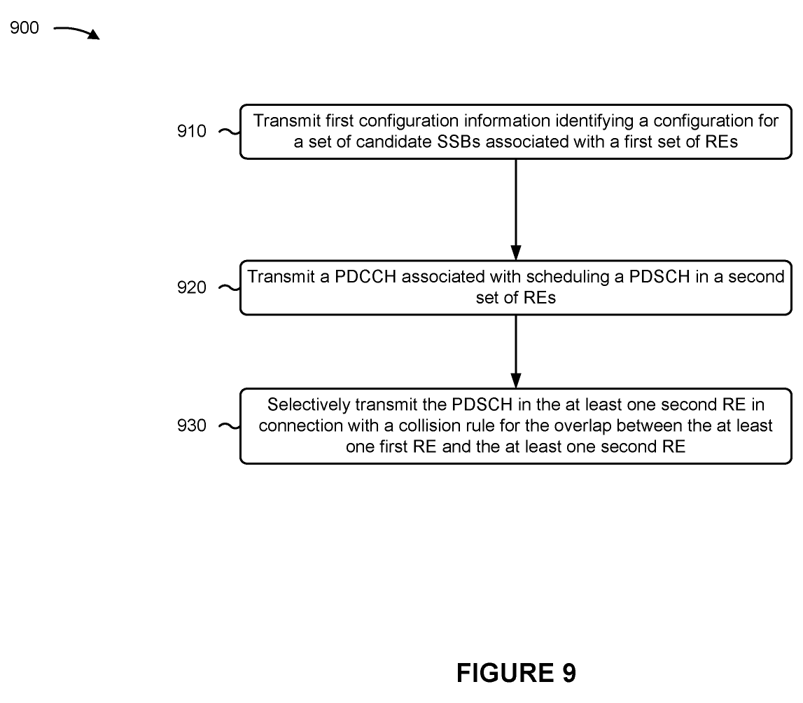

The network node 110, the processing system 145 of the network node 110, the UE 120, the processing system 140 of the UE 120, or any other component(s) of FIG. 1 may implement one or more techniques or perform one or more operations associated with downlink channel monitoring with OD-SSB transmission, as described in more detail elsewhere herein. For example, the processing system 145 of the network node 110, or the processing system 140 of the UE 120, may perform or direct operations of, for example, process 600 of FIG. 6, process 700 of FIG. 7, process 800 of FIG. 8, process 900 of FIG. 9, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, or interpreting the instructions, among other examples.

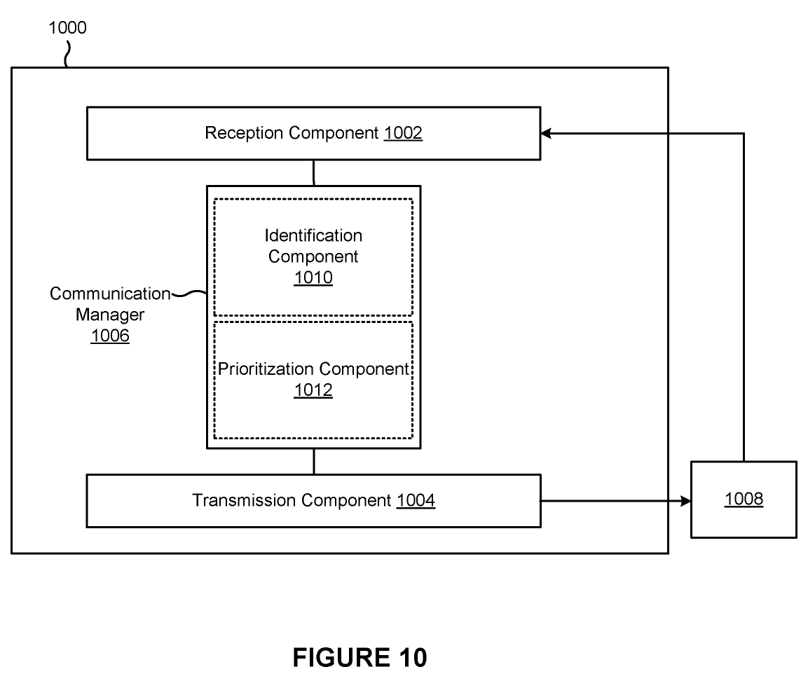

In some aspects, the UE 120 includes means for receiving first configuration information identifying a configuration for a set of candidate SSBs associated with a first set of REs; means for receiving second configuration information identifying a second set of REs for a set of PDCCH candidates; means for receiving third configuration information identifying one or more SSBs, of the set of candidate SSBs, that are transmitted in the first set of REs; or means for selectively monitoring a PDCCH candidate, of the set of PDCCH candidates, in accordance with the first configuration information, second configuration information, and third configuration information. In some aspects, the UE 120 includes means for receiving first configuration information identifying a configuration for a set of candidate SSBs associated with a first set of REs; means for receiving a PDCCH associated with scheduling a PDSCH in a second set of REs, wherein at least one first RE, of the first set of REs, overlaps with at least one second RE, of the second set of REs, corresponding to a PDCCH candidate of the set of PDCCH candidates; or means for selectively receiving the PDSCH in the at least one second RE in connection with a collision rule for the overlap between the at least one first RE and the at least one second RE. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

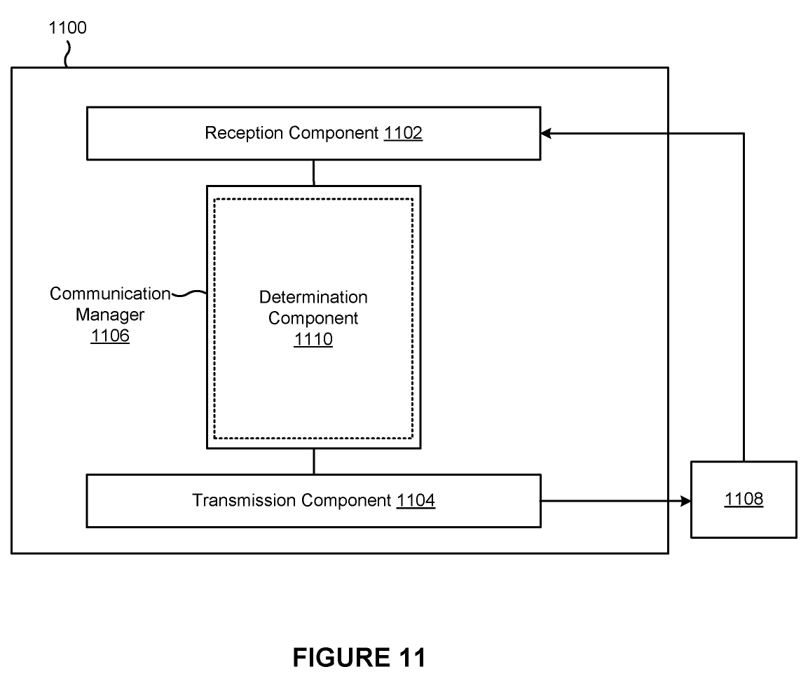

In some aspects, the network node 110 includes means for transmitting first configuration information identifying a configuration for a set of candidate SSBs associated with a first set of REs; means for transmitting second configuration information identifying a second set of REs for a set of PDCCH candidates; means for transmitting third configuration information identifying one or more SSBs, of the set of candidate SSBs, that are transmitted in the first set of REs; or means for selectively transmitting a PDCCH candidate, of the set of PDCCH candidates, in accordance with the first configuration information, second configuration information, and third configuration information. In some aspects, the network node 110 includes means for transmitting first configuration information identifying a configuration for a set of candidate SSBs associated with a first set of REs; means for transmitting a PDCCH associated with scheduling a PDSCH in a second set of REs, wherein at least one first RE, of the first set of REs, overlaps with at least one second RE, of the second set of REs, corresponding to a PDCCH candidate of the set of PDCCH candidates; or means for selectively transmitting the PDSCH in the at least one second RE in connection with a collision rule for the overlap between the at least one first RE and the at least one second RE. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

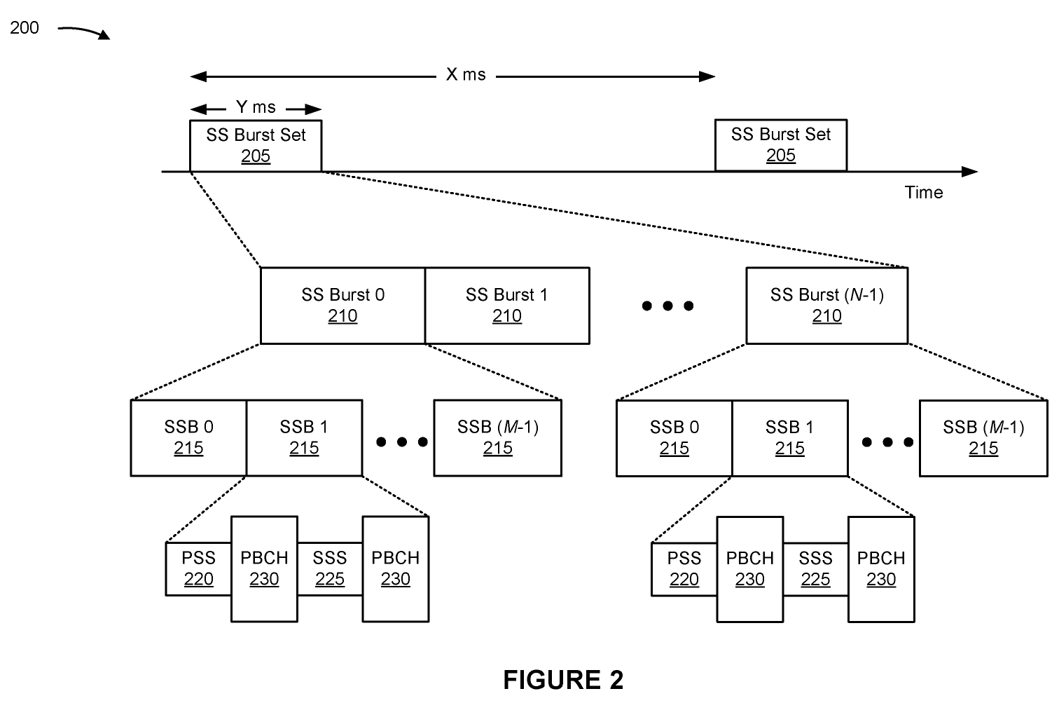

FIG. 2 is a diagram illustrating an example 200 of a synchronization signal (SS) hierarchy. As shown in FIG. 2, the SS hierarchy may include an SS burst set 205, which may include multiple SS bursts 210, shown as SS burst 0 through SS burst N-1, where N is a maximum number of repetitions of the SS burst 210 that may be transmitted by one or more network nodes. As further shown, each SS burst 210 may include one or more SSBs 215, shown as SSB 0 through SSB M-1, where M is a maximum number of SSBs 215 that can be carried by an SS burst 210. In some aspects, different SSBs 215 may be beam-formed differently (for example, transmitted using different beams), and may be used for cell search, cell acquisition, beam management, or beam selection (for example, as part of an initial network access procedure). An SS burst set 205 may be periodically transmitted by a wireless node (for example, a network node 110), such as every X milliseconds, as shown in FIG. 2. In some aspects, an SS burst set 205 may have a fixed or dynamic length, shown as Y milliseconds in FIG. 2. In some examples, an SS burst set 205 or an SS burst 210 may be referred to as a discovery reference signal (DRS) transmission window or an SSB measurement time configuration (SMTC) window.

In some aspects, an SSB 215 may include resources that carry a PSS 220, an SSS 225, or a PBCH 230. In some aspects, multiple SSBs 215 are included in an SS burst 210 (for example, with transmission on different beams), and the PSS 220, the SSS 225, or the PBCH 230 may be the same across each SSB 215 of the SS burst 210. In some aspects, a single SSB 215 may be included in an SS burst 210. In some aspects, the SSB 215 may be at least four symbols (for example, OFDM symbols) in length, where each symbol carries one or more of the PSS 220 (for example, occupying one symbol), the SSS 225 (for example, occupying one symbol), or the PBCH 230 (for example, occupying two symbols). In some aspects, an SSB 215 may be referred to as an SS/PBCH block.

In some aspects, the symbols of an SSB 215 are consecutive, as shown in FIG. 2. In some aspects, the symbols of an SSB 215 are non-consecutive. Similarly, in some aspects, one or more SSBs 215 of the SS burst 210 may be transmitted in consecutive radio resources (for example, consecutive symbols) during one or more slots. Additionally or alternatively, one or more SSBs 215 of the SS burst 210 may be transmitted in non-consecutive radio resources.

In some aspects, the SS bursts 210 may have a burst period, and the SSBs 215 of the SS burst 210 may be transmitted by a wireless node (for example, a network node 110) according to the burst period. In this example, the SSBs 215 may be repeated during each SS burst 210. In some aspects, the SS burst set 205 may have a burst set periodicity, whereby the SS bursts 210 of the SS burst set 205 are transmitted by the wireless node according to the fixed burst set periodicity. In other words, the SS bursts 210 may be repeated during each SS burst set 205.

In some aspects, an SSB 215 may include an SSB index, which may correspond to a beam used to carry the SSB 215. A UE 120 may monitor for or measure SSBs 215 using different receive (Rx) beams during an initial network access procedure or a cell search procedure, among other examples. Based at least in part on the monitoring or measuring, the UE 120 may indicate one or more SSBs 215 with a best signal parameter (for example, an RSRP parameter) to a network node 110 (for example, directly or via one or more other network nodes). The network node 110 and the UE 120 may use the one or more indicated SSBs 215 to select one or more beams to be used for communication between the network node 110 and the UE 120 (for example, for a random access channel (RACH) procedure). Additionally or alternatively, the UE 120 may use the SSB 215 or the SSB index to determine a cell timing for a cell via which the SSB 215 is received (for example, a serving cell).

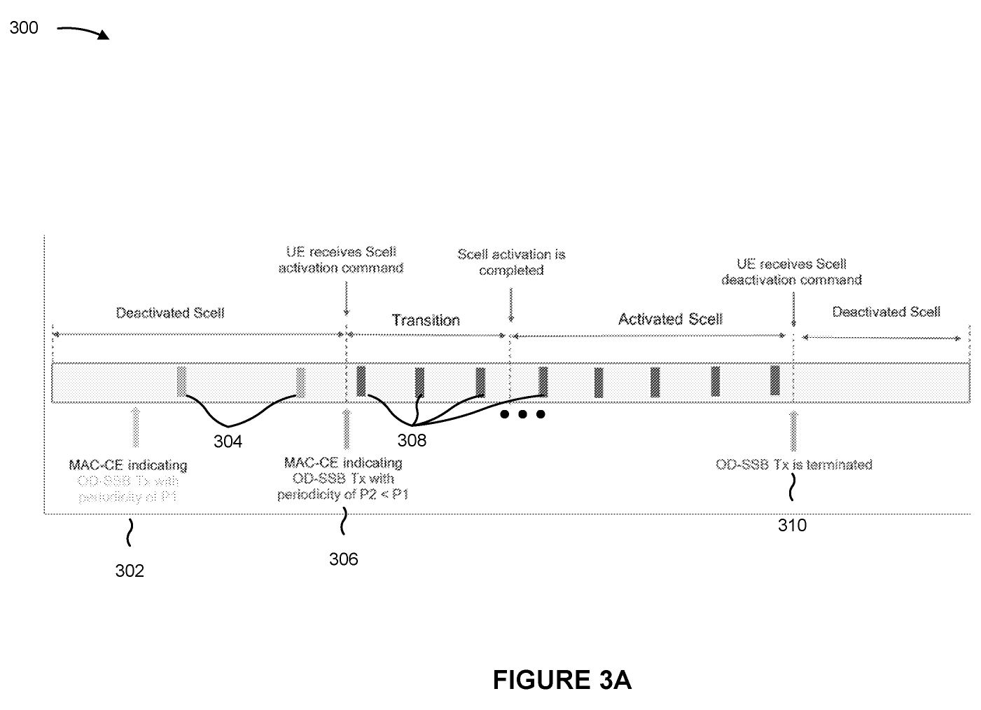

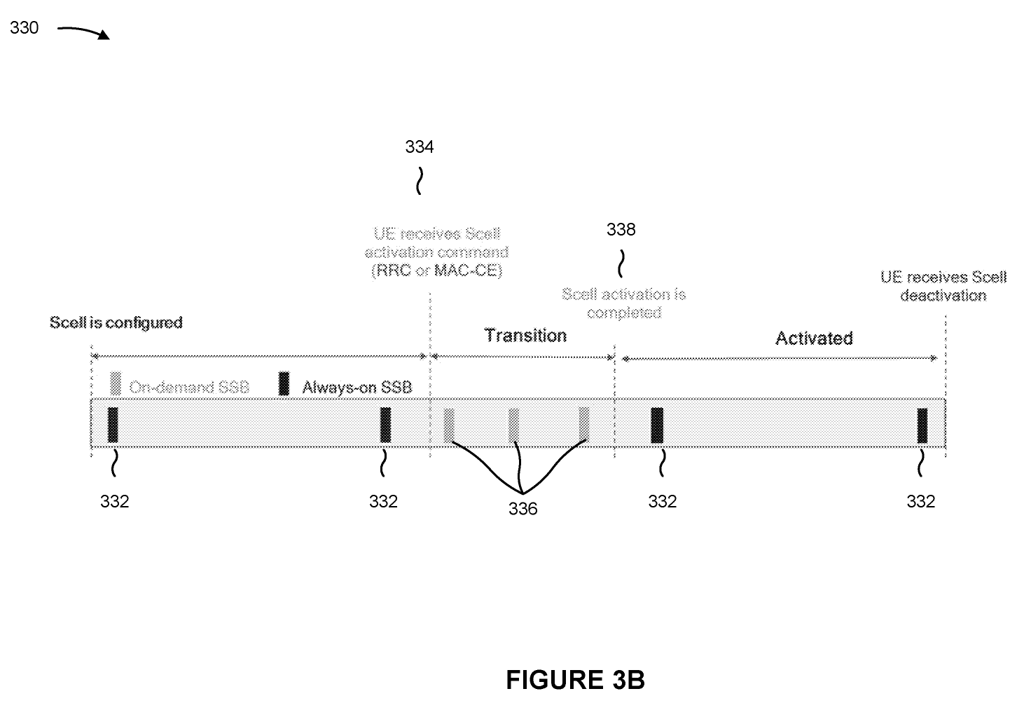

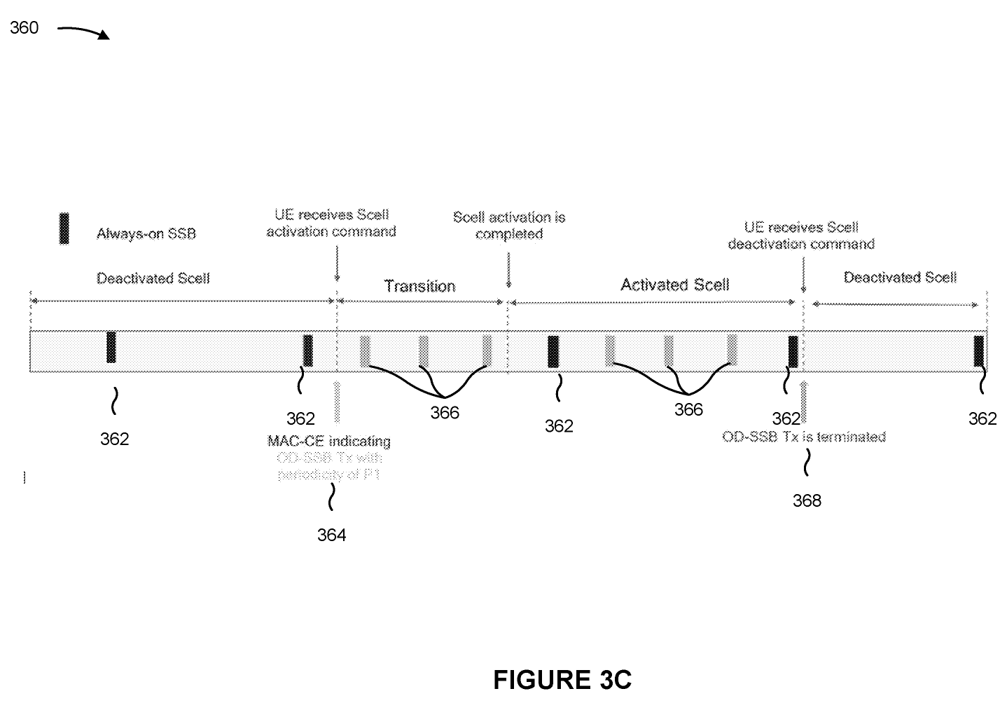

FIGS. 3A-3C are diagrams illustrating examples of SSB communications.

As shown in FIG. 3A, in example 300 of OD-SSB transmission, and as in a first operation 302, a network node 110 may transmit and a UE 120 may receive a MAC-CE indicating an OD-SSB transmission with a configured periodicity of P1. For example, the UE 120 may receive the MAC-CE on a primary cell (Pcell or PCell) or a secondary cell (Scell or SCell), which may indicate a transmission of an on-demand SSB. In a second operation 304, the network node 110 may transmit an SSB in accordance with the MAC-CE configuring the OD-SSB transmission with the periodicity of P1. In a third operation 306, the network node 110 may transmit, and the UE 120 may receive, an Scell activation command and a MAC-CE indicating an OD-SSB transmission with a new periodicity of P2, where P2 < P1. The network node 110 may transmit one or more SSBs, in a fourth operation 308, which may occur during a transition period (for example, which starts when the UE 120 receives the Scell activation command) and after an Scell has been activated. The SSBs are transmitted with the periodicity of P2 (for example, the network node 110 stops transmitting the SSBs with the periodicity of P1). In a firth operation 310, when the UE 120 receives an Scell deactivation command, the UE 120 may deactivate the Scell and the OD-SSB transmission with the periodicity of P2 may cease.

As shown in FIG. 3B, example 330 illustrates AO-SSBs being transmitted in a cell supporting OD-SSB Scell operation. For example, a network node 110 may transmit and a UE 120 may receive, when an Scell is configured but not activated, an AO-SSB on a PCell with a configured periodicity, in a first operation 332. As shown by in a second operation 334, when the UE 120 receives an Scell activation command (for example, via RRC signaling or MAC-CE) which triggers Scell activation and, in a third operation 336, transmission of a set of OD-SSBs by the network node 110. The OD-SSBs are transmitted during a transition period for Scell activation, but, in a fourth operation 338, when the Scell activation is complete, the network node 110 proceeds with transmitting the AO-SSBs according to the configured periodicity.

As shown in FIG. 3C, example 360 illustrates AO-SSBs being transmitted in a cell supporting OD-SSB Scell operation with OD-SSBs configured. In a first operation 362, the network node 110 transmits a set of AO-SSBs with a configured periodicity. In a second operation 364, the UE 120 receives an Scell activation command and a MAC-CE indicating OD-SSB transmission with a periodicity P1. The OD-SSB transmission occurs during the Scell transition period and continues when the Scell is activated, in a third operation 366. In a fourth operation 368, when the UE 120 receives an Scell deactivation command, OD-SSB transmission with the periodicity P1 is terminated (but AO-SSB transmission continues, as shown).

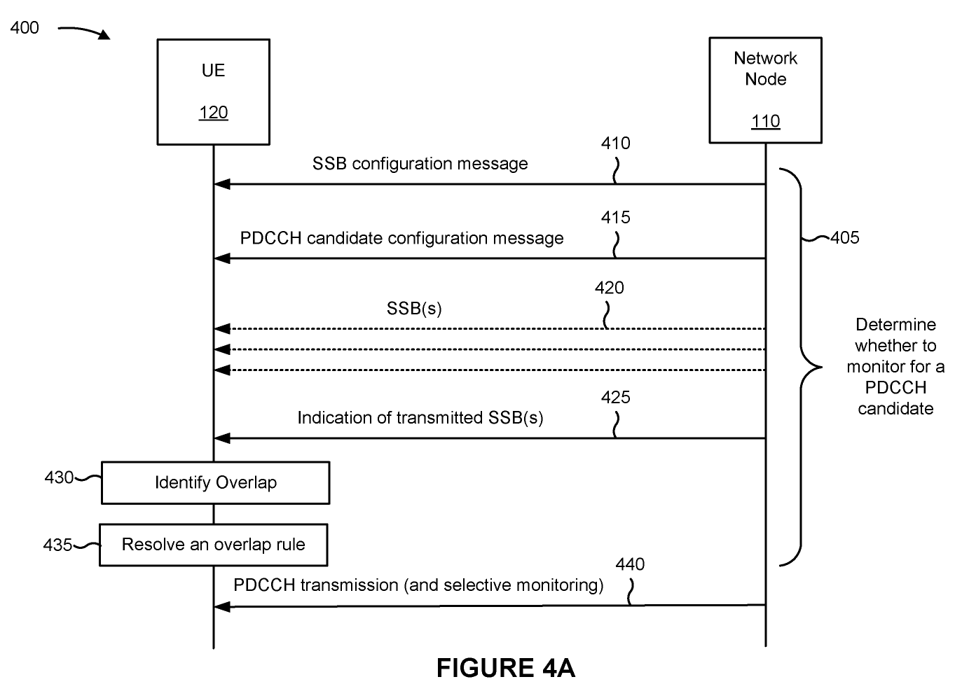

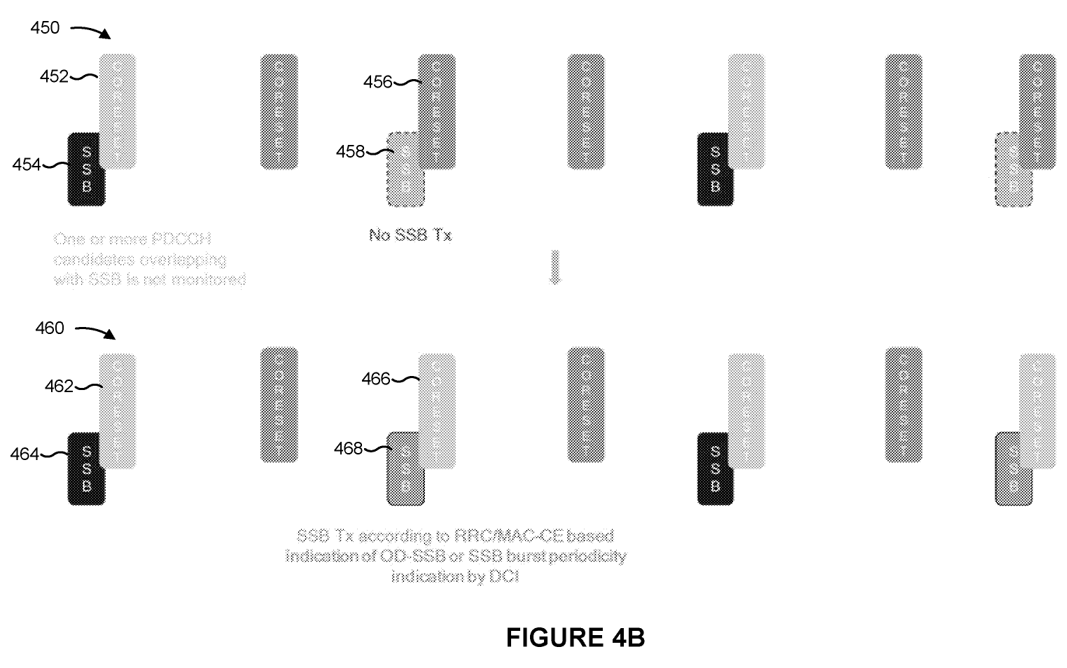

FIGS. 4A and 4B are diagrams illustrating an example 400 associated with PDCCH monitoring with OD-SSB transmission. As shown in FIG. 4A, example 400 includes communication between a network node 110 and a UE 120.

As further shown in FIG. 4A, in a first operation 405, the UE 120 may identify whether to monitor for a PDCCH candidate. For example, the UE 120 may identify a PDCCH monitoring occasion and may use configuration information to evaluate one or more rules and determine whether the UE 120 can monitor a configured search space for a PDCCH candidate.

In some aspects, the configuration information may include a first configuration message conveying SSB configuration information for a set of SSBs, in a second operation 410. For example, the UE 120 may receive, from the network node 110, configuration information configuring a set of candidate SSBs, as described in more detail herein. In some aspects, the configuration information may include a second configuration message, such as a PDCCH candidate configuration message, in a third operation 415. For example, the UE 120 may receive, from the network node 110, information identifying a set of PDCCH monitoring occasions, a CORESET, or a search space, among other examples, as described in more detail herein. In some aspects, the UE 120 may receive the configuration information, such as the first configuration message or a second configuration message, as described herein, in a type of communication. For example, the network node 110 may transmit RRC signaling to convey the first configuration message or the second configuration message, among other examples.

In some aspects, one or more of the set of candidate SSBs may be transmitted. For example, the network node 110 may transmit one or more SSBs to the UE 120, as shown, in a fourth operation 420. In some aspects, the configuration information may include a third configuration message conveying an indication of whether one or more SSBs, configured in accordance with the SSB configuration message, were transmitted, in a fifth operation 425. For example, the UE 120 may receive, from the network node 110, an indication of whether the one or more SSBs were transmitted. Additionally, or alternatively, the third configuration message may convey an indication or an activation of OD-SSB transmission. Additionally, or alternatively, the third configuration message may convey, via MAC-CE for example, a deactivation of OD-SSB transmission. Additionally, or alternatively, the UE 120 may identify a deactivation of OD-SSB transmission in connection with an expiration of a configured duration of N OD-SSB bursts in the first configuration information.

As shown in FIG. 4B, in a first example 450 of OD-SSB operation, based on the configuration messages, the UE 120 may be configured with a set of CORESETs, which may include a CORESET 452 that overlaps with an SSB 454 scheduled in accordance with an OD-SSB configuration and indicated as being transmitted in a configuration message. In some aspects, as described in more detail herein, the UE 120 may not monitor the CORESET 452 that overlaps with the SSB 454. In contrast, for another CORESET 456 that is scheduled to overlap with an SSB 458 scheduled in accordance with an OD-SSB configuration, the UE 120 receives a configuration message indicating that no SSB 458 is transmitted. Accordingly, the UE 120 may monitor the CORESET 456 to receive PDCCH. As further shown in FIG. 4B, in a second example 460 of SSB burst periodicity adaptation, based on the configuration messages, the UE 120 may be configured with a set of CORESETs, which may include a CORESET 462 that overlaps with an SSB 464 scheduled in accordance with an OD-SSB configuration and indicated as being transmitted in a configuration message. In some aspects, as described in more detail herein, the UE 120 may not monitor the CORESET 462 that overlaps with the SSB 464. Similarly, for another CORESET 466 that is scheduled to overlap with an SSB 468 scheduled in accordance with an SSB burst periodicity indication or an RRC or MAC-CE based indication of OD-SSB operation, the UE 120 may identify not to monitor the CORESET 466, as described in more detail herein.

In some aspects, to determine whether to monitor for a PDCCH candidate, the UE 120 may identify an overlap between a PDCCH candidate and an SSB, in a sixth operation 430. In some aspects, to determine whether to monitor for a PDCCH candidate, the UE 120 may resolve an overlap rule, in a seventh operation 435. For example, the UE 120 may identify, using an overlap rule, to monitor for the PDCCH candidate or to forgo monitoring of the PDCCH candidate. When the UE 120 monitors for the PDCCH candidate, the UE 120 may monitor a configured search space during a PDCCH transmission occasion to attempt to monitor the PDCCH. In this example, the UE 120 may monitor the PDCCH, which may schedule a PDSCH, as described in more detail herein. Additionally or alternatively, when the UE 120 forgoes monitoring the PDCCH candidate, the UE 120 may perform another action, such as monitoring for an SSB transmission or transmitting using an uplink resource rather than monitoring the configured search space.

In some aspects, the UE 120 may identify that the UE 120 is not to monitor the PDCCH candidate. For example, the UE 120 may be optionally able to monitor the PDCCH candidate, such as based on a UE capability, but the network node 110 does not assume that the UE 120 is to monitor the PDCCH candidate. In some aspects, the UE 120 may identify that the UE is not required to monitor the PDCCH candidate in connection with one or more received configuration messages. For example, when the UE 120 has received an OD-SSB configuration for a serving cell (for example, conveying an OD-SSB position in a burst, od-ssb-PositionsInBurst), and when the PDCCH candidate is not associated with a Type-0 PDCCH common search space (CSS) set, and when at least one RE of the PDCCH candidate overlaps with at least one RE of a candidate SSB (after puncturing) (for example, when the SSB candidate is associated with an SSB block index of conveyed by the OD-SSB configuration and is transmitted in accordance with the OD-SSB transmission operation in a cell), the UE 120 may identify that the UE 120 is not required to monitor the PDCCH candidate. Accordingly, the UE 120 may prioritize another communication operation, such as a receiving the candidate SSB, over monitoring the PDCCH candidate.

Additionally or alternatively, the UE 120 may identify whether the UE 120 is to monitor a PDCCH candidate in connection with an SSB burst periodicity adaptation message. For example, when the UE 120 has received an OD-SSB configuration for a serving cell, and when the PDCCH candidate is not associated with a Type-0 PDCCH CSS set, and when at least one RE of the PDCCH candidate overlaps with at least one RE of a candidate SSB (after puncturing) (for example, when the SSB candidate is associated with an SSB burst periodicity indication conveyed in a DCI format 2-9 message or MAC-CE indicating OD-SSB transmission), the UE 120 may identify that the UE 120 is not required to monitor the PDCCH candidate. Accordingly, the UE 120 may prioritize another communication operation, such as a receiving the candidate SSB, over monitoring the PDCCH candidate.

Additionally or alternatively, the UE 120 may identify that an SSB is not to be transmitted in connection with an overlap between a PDCCH candidate and an SSB. For example, the network node 110 may be configured to avoid transmitting an SSB, corresponding to an SSB block index provided by an OD-SSB configuration (for example, the od-ssb-PositionsInBurst parameter), in connection with an OD-SSB transmission operation in any RE for a PDCCH candidate. Similarly, the network node 110 may be configured to avoid transmitting an SSB, corresponding to an SSB block burst periodicity indication in a DCI format 2-9 message or MAC-CE indicating OD-SSB transmission, in any RE for a PDCCH candidate. In some aspects, rather than a DCI format 2-9 message or MAC-CE indicating OD-SSB transmission for conveying a burst periodicity indication, as described above, the UE 120 may receive another type of message for conveying a burst periodicity indication, such as a MAC-CE.

As further shown in FIG. 4A, in eighth operation 440, the UE 120 may selectively monitor for a PDCCH candidate. For example, when the UE 120 monitors for the PDCCH candidate, the UE 120 may monitor a configured search space during a PDCCH transmission occasion to attempt to monitor the PDCCH. In this example, the UE 120 may monitor the PDCCH, which may schedule a PDSCH, as described in more detail herein. Additionally or alternatively, when the UE 120 forgoes monitoring the PDCCH candidate, the UE 120 may perform another action, such as monitoring for an SSB transmission or transmitting using an uplink resource rather than monitoring the configured search space. Additionally, or alternatively, when the UE 120 determines that no SSB, corresponding to an SSB block index provided in an OD-SSB configuration, is transmitted in accordance with an OD-SSB transmission operation in REs colliding with REs of a PDCCH candidate, the UE 120 may monitor the PDCCH candidate. Similarly, when the UE 120 determines that no SSB, associated with an SSB burst periodicity indication conveyed in a MAC-CE or DCI, is transmitted in REs colliding with REs of a PDCCH candidate, the UE 120 may monitor the PDCCH candidate.

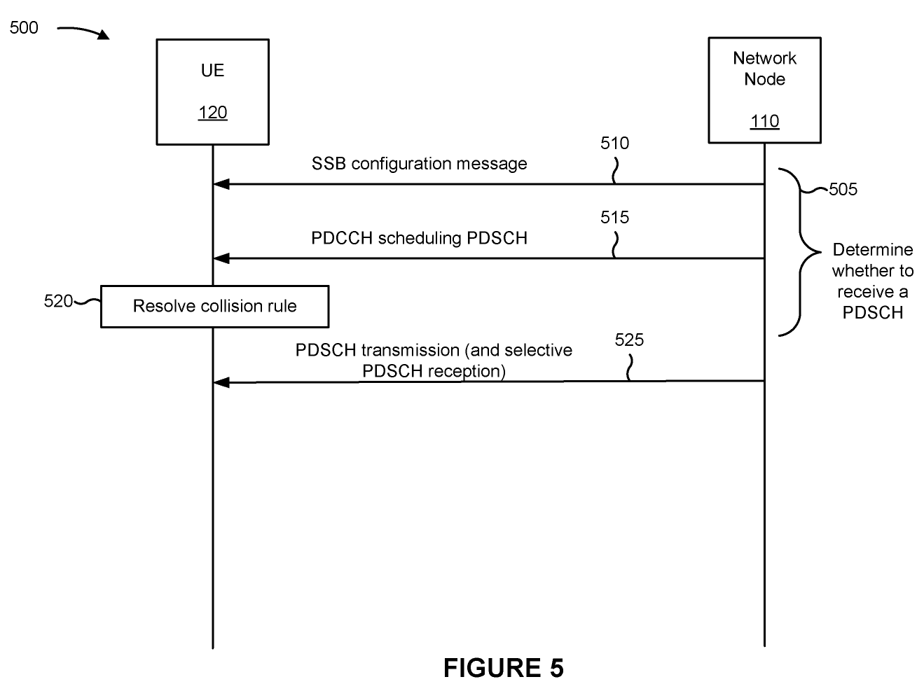

FIG. 5 is a diagram illustrating an example 500 associated with PDSCH reception with OD-SSB transmission. As shown in FIG. 5, example 500 includes communication between a network node 110 and a UE 120.

As further shown in FIG. 5, in a first operation 505, the UE 120 may identify whether to receive a PDSCH. For example, the UE 120 may identify a scheduled PDSCH resource, such as a PDSCH resource scheduled by a received PDCCH, may use configuration information to evaluate one or more rules and determine whether the UE 120 can receive the PDSCH.

In some aspects, the configuration information may include a first configuration message conveying SSB configuration information for a set of SSBs, in a second operation 510. For example, the UE 120 may receive, from the network node 110, configuration information configuring a set of candidate SSBs, as described in more detail herein. In some aspects, the configuration information may include a PDCCH, in a third operation 515. For example, the UE 120 may receive, from the network node 110, a PDCCH conveying a scheduling DCI that identifies a set of resources for receiving a PDSCH, as described in more detail herein. In some aspects, to determine whether to receive a PDSCH transmission, the UE 120 may receive a collision rule, in a fourth operation 520. For example, the UE 120 may resolve a collision rule with respect to a PDSCH and another transmission, such as an SSB among other examples, and determine whether to receive the PDSCH or perform a communication operation associated with the other transmission.

In some aspects, the UE 120 may identify a collision and resolve the collision using a collision rule. For example, the UE 120, which supports OD-SSB Scell operation, may determine that an SSB transmission, configured in accordance with an OD-SSB configuration (for example, a parameter od-ssb-PositionsInBurst), is in a resource that overlaps with physical resource blocks (PRBs) of a PDSCH resource allocation (after puncturing). In this example, in accordance with a collision rule, the UE 120 may identify that the PRBs that include the SSB transmission resources are not available for reception of the PDSCH in one or more OFDM symbols where the SSB, with the same physical cell identifier (PCI) as the PDSCH, is transmitted. In some aspects, rate matching for PDSCH in a cell supporting OD-SSB operation is performed by the UE 120 such that PRBs containing SSB transmission resources, as indicated by od-ssb-PositionsInBurst, are excluded from PDSCH reception during OFDM symbols in which the SSB is transmitted. This ensures that PDSCH resource allocation does not overlap with the SS/PBCH block transmission associated with on-demand SSB. Accordingly, the collision rule may indicate that if the resource elements (REs) or PRBs allocated for PDCCH or PDSCH overlap with REs used for SSB transmission, the UE 120 is to assume that the overlapping resources are not available for PDCCH or PDSCH reception in the corresponding OFDM symbols. This prevents concurrent use of the same resources for both control/data and SSB transmission.

Similarly, the UE 120, which supports SSB burst periodicity adaptation using a DCI format 2-9 message, may determine that an SSB transmission, configured in accordance with an SSB burst periodicity adaptation message, is in a resource that overlaps with PRBs of a PDSCH resource allocation (after puncturing). In this example, in accordance with a collision rule, the UE 120 may identify that the PRBs that include the SSB transmission resources are not available for reception of the PDSCH in one or more OFDM symbols where the SSB, with the same PCI as the PDSCH, is transmitted. In another example, in accordance with a collision rule, the UE 120 may identify that the PRBs that include the SSB transmission resources are not available for reception of the PDSCH in one or more OFDM symbols where the SSB, with a different PCI from the PCI used for the PDSCH, is transmitted.

In some aspects, the UE 120 may identify that no SSB is transmitted in an RE being used by the UE 120 for reception of a PDSCH. For example, when the UE 120 has received an OD-SSB configuration (for example, an od-ssb-PositionsInBurst) for a serving cell, and when the UE 120 is to receive a PDSCH scheduled by a PDCCH with a cyclic redundancy check (CRC) scrambled by a system information (SI) radio network temporary identifier (RNTI) (SI-RNTI), a random access (RA) RNTI (RA-RNTI), a RA message B (msgB) RNTI (msgB-RNTI), a paging RNTI (P-RNTI), or a temporary cell (TC) RNTI (TC-RNTI), the UE 120 determine that no SSB corresponding to an SSB block index in the OD-SSB configuration (after puncturing) is transmitted in accordance with OD-SSB operation in REs used by the UE 120 for reception of the PDSCH. Additionally or alternatively, when the UE 120 receives a PDSCH scheduled by a PDCCH with a CRC scrambled by an SI-RNTI for a system information block (SIB) type-1 (SIB1) in the serving cell, the UE 120 may identify that no SSB corresponding to the SSB block index in the OD-SSB configuration is transmitted in accordance with OD-SSB operation in REs used by the UE for reception of the PDSCH. In this example, the UE 120 may receive the PDSCH in resources that would be scheduled to collide with SSB transmission. In other words, the UE 120 may be configured to assume that the collision does not occur and the UE 120 can receive the PDSCH. Additionally or alternatively, when the UE 120 is to receive a PDSCH scheduled by a PDCCH with a CRC scrambled by a SI-RNTI for other SI, P-RNTI, RA-RNTI, msgB-RNTI, or TC-RNTI in the serving cell, the UE 120 may identify that SSB transmission resources (for example, one or more PRBs) for an OD-SSB transmission operation are not available for PDSCH reception in the OFDM symbols in which the SSB is transmitted. In this example, the UE 120 may forgo receiving the PDSCH in resources that collide with SSB transmission.

Additionally or alternatively, when the UE 120 has received an OD-SSB configuration (for example, an od-ssb-PositionsInBurst) for a serving cell and an SSB burst periodicity indication (for example, in a MAC-CE or DCI), and when the UE 120 is to receive a PDSCH scheduled by a PDCCH with a CRC scrambled by an SI-RNTI, an RA-RNTI, an msgB-RNTI, a P-RNTI, or a TC-RNTI, the UE 120 determine that no SSB corresponding to an SSB block index in the OD-SSB configuration (after puncturing) is transmitted in accordance with the SSB burst periodicity indication in REs used by the UE 120 for reception of the PDSCH. Additionally or alternatively, when the UE 120 receives a PDSCH scheduled by a PDCCH with a CRC scrambled by an SI-RNTI for a SIB-1 in the serving cell, the UE 120 may identify that no SSB corresponding to the SSB block index in the OD-SSB configuration is transmitted in accordance with the SSB burst periodicity indication in REs used by the UE for reception of the PDSCH. Additionally or alternatively, when the UE 120 is to receive a PDSCH scheduled by a PDCCH with a CRC scrambled by a SI-RNTI for other SI, P-RNTI, RA-RNTI, msgB-RNTI, or TC-RNTI in the serving cell, the UE 120 may identify that SSB transmission resources (for example, one or more PRBs) for an OD-SSB transmission operation according to the SSB burst periodicity indication are not available for PDSCH reception in the OFDM symbols in which the SSB is transmitted.

As further shown in FIG. 5, in a fifth operation 525, the UE 120 may selectively receive the PDSCH. For example, when the UE 120 monitors for the PDSCH, the UE 120 may receive the PDSCH. Additionally or alternatively, when the UE 120 forgoes monitoring for the PDSCH, the UE 120 may perform another action, such as monitoring for an SSB transmission or transmitting using an uplink resource rather than monitoring for the PDSCH.

FIG. 6 is a flowchart illustrating an example process 600 performed, for example, at a UE or an apparatus of a UE that supports downlink channel monitoring with OD-SSB transmission. Example process 600 is an example where the apparatus or the UE (for example, UE 120) performs operations associated with PDCCH monitoring with OD-SSB transmission.

As shown in FIG. 6, in some aspects, process 600 may include receiving first configuration information identifying a configuration for a set of candidate SSBs associated with a first set of REs (block 610). For example, the UE (such as by using communication manager 150 or reception component 1002, depicted in FIG. 10) may wirelessly receive first configuration information identifying a configuration for a set of candidate SSBs associated with a first set of REs, as described above, such as in connection with operation 410 and FIG. 4A.

As further shown in FIG. 6, in some aspects, process 600 may include receiving second configuration information identifying a second set of REs for a set of PDCCH candidates (block 620). For example, the UE (such as by using communication manager 150 or reception component 1002, depicted in FIG. 10) may wirelessly receive second configuration information identifying a second set of REs for a set PDCCH candidates, as described above, such as in connection with operation 415 and FIG. 4A.

As further shown in FIG. 6, in some aspects, process 600 may include receiving third configuration information identifying one or more SSBs, of the set of candidate SSBs, that are transmitted in the first set of REs (block 630). For example, the UE (such as by using communication manager 150 or reception component 1002, depicted in FIG. 10) may wirelessly receive third configuration information identifying one or more SSBs, of the set of candidate SSBs, that are transmitted in the first set of REs, as described above, such as in connection with operation 425 and FIG. 4A.

As further shown in FIG. 6, in some aspects, process 600 may include selectively monitoring a PDCCH candidate, of the set of PDCCH candidates, in accordance with the first configuration information, second configuration information, and third configuration information (block 640). For example, the UE (such as by using communication manager 150 or reception component 1002, depicted in FIG. 10) may selectively monitor, via a wireless link, a PDCCH candidate, of the set of PDCCH candidates, in accordance with the first configuration information, second configuration information, and third configuration information, as described above, such as in connection with operation 440 and FIG. 4A.

Process 600 may include additional aspects, such as any single aspect or any combination of aspects described below or in connection with one or more other processes described elsewhere herein.

In a first additional aspect, the third configuration information is conveyed via at least one of radio resource control signaling, MAC-CE signaling, or DCI signaling.

In a second additional aspect, alone or in combination with the first aspect, the first configuration information includes an indication of an SSB index for a serving cell, and wherein at least one first RE of the first set of REs corresponds to an SSB block index included in the first configuration information.

In a third additional aspect, alone or in combination with one or more of the first and second aspects, the set of PDCCH candidates are not associated with a type-0 PDCCH common search space set.

In a fourth additional aspect, alone or in combination with one or more of the first through third aspects, at least one first RE, of the first set of REs, overlaps with at least one second RE, of the second set of REs, corresponding to a PDCCH candidate of the set of PDCCH candidates, and selectively monitoring the PDCCH candidate comprises forgoing monitoring the PDCCH candidate in connection with the overlap between the at least one first RE and the at least one second RE.

In a fifth additional aspect, alone or in combination with one or more of the first through fourth aspects, process 600 includes monitoring the PDCCH candidate, wherein at least one second RE of the PDCCH does not overlap with at least one first RE of the one or more SSBs that are transmitted in accordance with the third configuration information.

In a sixth additional aspect, alone or in combination with one or more of the first through fifth aspects, process 600 includes monitoring the PDCCH candidate, wherein the PDCCH candidate is associated with scheduling a PDSCH.

In a seventh additional aspect, alone or in combination with one or more of the first through sixth aspects, a resource allocation for the PDSCH overlaps with one or more PRBs that provide a transmission resource for an SSB of the one or more SSBs that are transmitted in accordance with the third configuration information, and wherein the one or more PRBs are not available for the PDSCH.

In an eighth additional aspect, alone or in combination with one or more of the first through seventh aspects, the PDSCH and the SSB are associated with a common physical cell identity.

In a ninth additional aspect, alone or in combination with one or more of the first through eighth aspects, the third configuration information includes information identifying a burst periodicity indication of the set of candidate SSBs, and wherein at least one first RE, of the first set of REs, is for an SSB, of the set of candidate SSBs, that is transmitted in accordance with the third configuration information.

In a tenth additional aspect, alone or in combination with one or more of the first through ninth aspects, the first configuration information includes an indication of an SSB index for a serving cell, and wherein the at least one first RE, of the SSB, corresponds to an SSB block index included in the first configuration information.

In an eleventh additional aspect, alone or in combination with one or more of the first through tenth aspects, the set of PDCCH candidates are not associated with a type-0 PDCCH common search space set.

In a twelfth additional aspect, alone or in combination with one or more of the first through eleventh aspects, process 600 includes monitoring the PDCCH candidate, wherein the PDCCH candidate is associated with scheduling a PDSCH.

In a thirteenth additional aspect, alone or in combination with one or more of the first through twelfth aspects, a resource allocation for the PDSCH overlaps with one or more PRBs that provide a transmission resource for the SSB that is transmitted in accordance with the burst periodicity indication in the third configuration information, and wherein the one or more PRBs are not available for the PDSCH.

In a fourteenth additional aspect, alone or in combination with one or more of the first through thirteenth aspects, the PDSCH and the SSB are associated with a common physical cell identity.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a UE or an apparatus of a UE that supports downlink monitoring with OD-SSB transmission. Example process 700 is an example where the apparatus or the UE (for example, UE 120) performs operations associated with PDSCH reception with OD-SSB transmission.

As shown in FIG. 7, in some aspects, process 700 may include receiving first configuration information identifying a configuration for a set of candidate SSBs associated with a first set of REs (block 710). For example, the UE (such as by using communication manager 150 or reception component 1002, depicted in FIG. 10) may wirelessly receive first configuration information identifying a configuration for a set of candidate SSBs associated with a first set of REs, as described above, such as in connection with operation 510 and FIG. 5.

As further shown in FIG. 7, in some aspects, process 700 may include receiving a PDCCH associated with scheduling a PDSCH in a second set of REs (block 720). For example, the UE (such as by using communication manager 150 or reception component 1002, depicted in FIG. 10) may monitor, via a wireless link, a PDCCH associated with scheduling a PDSCH in a second set of REs, wherein at least one first RE, of the first set of REs, overlaps with at least one second RE, of the second set of REs, corresponding to a PDCCH candidate of the set of PDCCH candidates, as described above, such as in connection with operation 515 and FIG. 5.

As further shown in FIG. 7, in some aspects, process 700 may include selectively receiving the PDSCH in the at least one second RE in connection with a collision rule for the overlap between the at least one first RE and the at least one second RE (block 730). For example, the UE (such as by using communication manager 150 or reception component 1002, depicted in FIG. 10) may selectively wirelessly receive the PDSCH in the at least one second RE in connection with a collision rule for the overlap between the at least one first RE and the at least one second RE, as described above, such as in connection with operation 525 and FIG. 5.

Process 700 may include additional aspects, such as any single aspect or any combination of aspects described below or in connection with one or more other processes described elsewhere herein.

In a first additional aspect, process 700 includes receiving third configuration information identifying one or more SSBs, of the set of candidate SSBs, that are transmitted in the first set of REs, wherein the at least one first RE is for an SSB, of the one or more SSBs, that is transmitted.

In a second additional aspect, alone or in combination with the first aspect, the PDCCH is associated with a CRC that is scrambled with at least one of a system information RNTI, a random access RNTI, a random access message B RNTI, a paging RNTI, or a temporary cell RNTI, and selectively receiving the PDSCH comprises receiving the PDSCH, wherein a resource allocation for the PDSCH does not overlap with one or more PRBs that provide a transmission resource for the one or more SSBs that are transmitted in accordance with the third configuration information.

In a third additional aspect, alone or in combination with one or more of the first and second aspects, the PDCCH is associated with a CRC that is scrambled with at least one of a system information RNTI, a random access RNTI, a random access message B RNTI, a paging RNTI, or a temporary cell RNTI, and selectively receiving the PDSCH comprises receiving the PDSCH, wherein a resource allocation for the PDSCH overlaps with one or more PRBs that provide a transmission resource for the one or more SSBs that is transmitted in accordance with the third configuration information, and wherein the one or more PRBs are not available for the PDSCH.

In a fourth additional aspect, alone or in combination with one or more of the first through third aspects, the PDCCH is associated with a CRC that is scrambled with a system information radio network temporary identifier for at least one of another system information, a paging RNTI, a random access RNTI, a random access message B RNTI, or a temporary cell RNTI, and selectively receiving the PDSCH comprises forgoing receiving the PDSCH.

In a fifth additional aspect, alone or in combination with one or more of the first through fourth aspects, process 700 includes receiving third configuration information identifying a burst periodicity indication of the set of candidate SSBs, and wherein the at least one first RE is for an SSB, of the set of candidate SSBs, that is transmitted in accordance with the burst periodicity indication.

In a sixth additional aspect, alone or in combination with one or more of the first through fifth aspects, the PDCCH is associated with a CRC that is scrambled with at least one of a system information RNTI, a random access RNTI, a random access message B RNTI, a paging RNTI, or a temporary cell RNTI, and selectively receiving the PDSCH comprises receiving the PDSCH, wherein a resource allocation for the PDSCH does not overlap with one or more PRBs that provide a transmission resource for the one or more SSBs that are transmitted in accordance with the third configuration information.

In a seventh additional aspect, alone or in combination with one or more of the first through sixth aspects, the PDCCH is associated with a CRC that is scrambled with at least one of a system information RNTI, a random access RNTI, a random access message B RNTI, a paging RNTI, or a temporary cell RNTI, and selectively receiving the PDSCH comprises receiving the PDSCH, wherein a resource allocation for the PDSCH overlaps with one or more PRBs that provide a transmission resource for the one or more SSBs that is transmitted in accordance with the third configuration information, and wherein the one or more PRBs are not available for the PDSCH.

In an eighth additional aspect, alone or in combination with one or more of the first through seventh aspects, the PDCCH is associated with a CRC that is scrambled with a system information radio network temporary identifier for at least one of another system information, a paging RNTI, a random access RNTI, a random access message B RNTI, or a temporary cell RNTI, and selectively receiving the PDSCH comprises forgoing receiving the PDSCH.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports downlink channel monitoring with OD-SSB transmission. Example process 800 is an example where the apparatus or the network node (for example, network node 110) performs operations associated with PDCCH monitoring with OD-SSB transmission.

As shown in FIG. 8, in some aspects, process 800 may include transmitting first configuration information identifying a configuration for a set of candidate SSBs associated with a first set of REs (block 810). For example, the network node (such as by using communication manager 155 or transmission component 1104, depicted in FIG. 11) may wirelessly transmit first configuration information identifying a configuration for a set of candidate SSBs associated with a first set of REs, as described above, such as in connection with operation 410 and FIG. 4A.

As further shown in FIG. 8, in some aspects, process 800 may include transmitting second configuration information identifying a second set of REs for a set of PDCCH candidates (block 820). For example, the network node (such as by using communication manager 155 or transmission component 1104, depicted in FIG. 11) may wirelessly transmit second configuration information identifying a second set of REs for a set of PDCCH candidates, as described above, such as in connection with operation 415 and FIG. 4A.

As further shown in FIG. 8, in some aspects, process 800 may include transmitting third configuration information identifying one or more SSBs, of the set of candidate SSBs, that are transmitted in the first set of REs (block 830). For example, the network node (such as by using communication manager 155 or transmission component 1104, depicted in FIG. 11) may wirelessly transmit third configuration information identifying one or more SSBs, of the set of candidate SSBs, that are transmitted in the first set of REs, as described above, such as in connection with operation 425 and FIG. 4A.

As further shown in FIG. 8, in some aspects, process 800 may include selectively transmitting a PDCCH candidate, of the set of PDCCH candidates, in accordance with the first configuration information, second configuration information, and third configuration information (block 840). For example, the network node (such as by using communication manager 155 or transmission component 1104, depicted in FIG. 11) may selectively wirelessly transmit a PDCCH candidate, of the set of PDCCH candidates, in accordance with the first configuration information, second configuration information, and third configuration information, as described above, such as in connection with operation 440 and FIG. 4A.

Process 800 may include additional aspects, such as any single aspect or any combination of aspects described below or in connection with one or more other processes described elsewhere herein.

In a first additional aspect, the third configuration information is conveyed via at least one of radio resource control signaling, MAC-CE signaling, or downlinking control information signaling.

In a second additional aspect, alone or in combination with the first aspect, the first configuration information includes an indication of an SSB index for a serving cell, and wherein at least one first RE of the first set of REs corresponds to an SSB block index included in the first configuration information.

In a third additional aspect, alone or in combination with one or more of the first and second aspects, the set of PDCCH candidates are not associated with a type-0 PDCCH common search space set.

In a fourth additional aspect, alone or in combination with one or more of the first through third aspects, at least one first RE, of the first set of REs, overlaps with at least one second RE, of the second set of REs, corresponding to a PDCCH candidate of the set of PDCCH candidates, and selectively transmitting the PDCCH candidate comprises forgoing transmitting the PDCCH candidate in connection with the overlap between the at least one first RE and the at least one second RE.

In a fifth additional aspect, alone or in combination with one or more of the first through fourth aspects, process 800 includes transmitting the PDCCH candidate, wherein at least one second RE of the PDCCH does not overlap with at least one first RE of the one or more SSBs that are transmitted in accordance with the third configuration information.

In a sixth additional aspect, alone or in combination with one or more of the first through fifth aspects, process 800 includes transmitting the PDCCH candidate, wherein the PDCCH candidate is associated with scheduling a PDSCH.

In a seventh additional aspect, alone or in combination with one or more of the first through sixth aspects, a resource allocation for the PDSCH overlaps with one or more PRBs that provide a transmission resource for an SSB of the one or more SSBs that are transmitted in accordance with the third configuration information, and wherein the one or more PRBs are not available for the PDSCH.

In an eighth additional aspect, alone or in combination with one or more of the first through seventh aspects, the PDSCH and the SSB are associated with a common physical cell identity.

In a ninth additional aspect, alone or in combination with one or more of the first through eighth aspects, the third configuration information includes information identifying a burst periodicity indication of the set of candidate SSBs, and wherein at least one first RE, of the first set of REs, is for an SSB, of the set of candidate SSBs, that is transmitted in accordance with the third configuration information.

In a tenth additional aspect, alone or in combination with one or more of the first through ninth aspects, the first configuration information includes an indication of an SSB index for a serving cell, and wherein the at least one first RE, of the SSB, corresponds to an SSB block index included in the first configuration information.

In an eleventh additional aspect, alone or in combination with one or more of the first through tenth aspects, the set of PDCCH candidates are not associated with a type-0 PDCCH common search space set.

In a twelfth additional aspect, alone or in combination with one or more of the first through eleventh aspects, process 800 includes transmitting the PDCCH candidate, wherein the PDCCH candidate is associated with scheduling a PDSCH.

In a thirteenth additional aspect, alone or in combination with one or more of the first through twelfth aspects, a resource allocation for the PDSCH overlaps with one or more PRBs that provide a transmission resource for the SSB that is transmitted in accordance with the burst periodicity indication in the third configuration information, and wherein the one or more PRBs are not available for the PDSCH.

In a fourteenth additional aspect, alone or in combination with one or more of the first through thirteenth aspects, the PDSCH and the SSB are associated with a common physical cell identity.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a network node or an apparatus of a network node that supports downlink channel monitoring with OD-SSB transmission. Example process 900 is an example where the apparatus or the network node (for example, network node 110) performs operations associated with PDSCH reception with OD-SSB transmission.

As shown in FIG. 9, in some aspects, process 900 may include transmitting first configuration information identifying a configuration for a set of candidate SSBs associated with a first set of REs (block 910). For example, the network node (such as by using communication manager 155 or transmission component 1104, depicted in FIG. 11) may wirelessly transmit first configuration information identifying a configuration for a set of candidate SSBs associated with a first set of REs, as described above, such as in connection with operation 510 and FIG. 5.

As further shown in FIG. 9, in some aspects, process 900 may include transmitting a PDCCH associated with scheduling a PDSCH in a second set of REs (block 920). For example, the network node (such as by using communication manager 155 or transmission component 1104, depicted in FIG. 11) may wirelessly transmit a PDCCH associated with scheduling a PDSCH in a second set of REs, wherein at least one first RE, of the first set of REs, overlaps with at least one second RE, of the second set of REs, corresponding to a PDCCH candidate of the set of PDCCH candidates, as described above, such as in connection with operation 515 and FIG. 5.

As further shown in FIG. 9, in some aspects, process 900 may include selectively transmitting the PDSCH in the at least one second RE in connection with a collision rule for the overlap between the at least one first RE and the at least one second RE (block 930). For example, the network node (such as by using communication manager 155 or transmission component 1104, depicted in FIG. 11) may selectively wirelessly transmit the PDSCH in the at least one second RE in connection with a collision rule for the overlap between the at least one first RE and the at least one second RE, as described above, such as in connection with operation 525 and FIG. 5.

Process 900 may include additional aspects, such as any single aspect or any combination of aspects described below or in connection with one or more other processes described elsewhere herein.

In a first additional aspect, process 900 includes transmitting third configuration information identifying one or more SSBs, of the set of candidate SSBs, that are transmitted in the first set of REs, wherein the at least one first RE is for an SSB, of the one or more SSBs, that is transmitted.

In a second additional aspect, alone or in combination with the first aspect, the PDCCH is associated with a CRC that is scrambled with at least one of a system information RNTI, a random access RNTI, a random access message B RNTI, a paging RNTI, or a temporary cell RNTI, and selectively transmitting the PDSCH comprises transmitting the PDSCH, wherein a resource allocation for the PDSCH does not overlap with one or more PRBs that provide a transmission resource for the one or more SSBs that are transmitted in accordance with the third configuration information.

In a third additional aspect, alone or in combination with one or more of the first and second aspects, the PDCCH is associated with a CRC that is scrambled with at least one of a system information RNTI, a random access RNTI, a random access message B RNTI, a paging RNTI, or a temporary cell RNTI, and selectively transmitting the PDSCH comprises transmitting the PDSCH, wherein a resource allocation for the PDSCH overlaps with one or more PRBs that provide a transmission resource for the one or more SSBs that is transmitted in accordance with the third configuration information, and wherein the one or more PRBs are not available for the PDSCH.

In a fourth additional aspect, alone or in combination with one or more of the first through third aspects, the PDCCH is associated with a CRC that is scrambled with a system information radio network temporary identifier for at least one of another system information, a paging RNTI, a random access RNTI, a random access message B RNTI, or a temporary cell RNTI, and selectively transmitting the PDSCH comprises forgoing transmitting the PDSCH.

In a fifth additional aspect, alone or in combination with one or more of the first through fourth aspects, process 900 includes transmitting third configuration information identifying a burst periodicity indication of the set of candidate SSBs, and wherein the at least one first RE is for an SSB, of the set of candidate SSBs, that is transmitted in accordance with the burst periodicity indication.

In a sixth additional aspect, alone or in combination with one or more of the first through fifth aspects, the PDCCH is associated with a CRC that is scrambled with at least one of a system information RNTI, a random access RNTI, a random access message B RNTI, a paging RNTI, or a temporary cell RNTI, and selectively transmitting the PDSCH comprises transmitting the PDSCH, wherein a resource allocation for the PDSCH does not overlap with one or more PRBs that provide a transmission resource for the one or more SSBs that are transmitted in accordance with the third configuration information.

In a seventh additional aspect, alone or in combination with one or more of the first through sixth aspects, the PDCCH is associated with a CRC that is scrambled with at least one of a system information RNTI, a random access RNTI, a random access message B RNTI, a paging RNTI, or a temporary cell RNTI, and selectively transmitting the PDSCH comprises transmitting the PDSCH, wherein a resource allocation for the PDSCH overlaps with one or more PRBs that provide a transmission resource for the one or more SSBs that is transmitted in accordance with the third configuration information, and wherein the one or more PRBs are not available for the PDSCH.

In an eighth additional aspect, alone or in combination with one or more of the first through seventh aspects, the PDCCH is associated with a CRC that is scrambled with a system information radio network temporary identifier for at least one of another system information, a paging RNTI, a random access RNTI, a random access message B RNTI, or a temporary cell RNTI, and comprising forgoing transmitting the PDSCH.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports downlink channel monitoring with OD-SSB transmission. The apparatus 1000 may be a UE, or a UE may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 140). In some aspects, the communication manager 1006 is the communication manager 150

In some aspects, the apparatus 1000 may be configured to or operable to perform one or more operations described herein in connection with FIGS. 4A-5. Additionally or alternatively, the apparatus 1000 may be configured to or operable to perform one or more processes described herein, such as process 600 of FIG. 6, or process 700 of FIG. 7.

The reception component 1002 may receive communications, such as reference signals, control information, or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE. In some aspects, the transmission component 1004 may be co-located with the reception component 1002.

The communication manager 1006 may receive or may cause the reception component 1002 to receive first configuration information identifying a configuration for a set of candidate SSBs associated with a first set of REs. The communication manager 1006 may receive or may cause the reception component 1002 to receive second configuration information identifying a second set of REs for a set of PDCCH candidates. The communication manager 1006 may receive or may cause the reception component 1002 to receive third configuration information identifying one or more SSBs, of the set of candidate SSBs, that are transmitted in the first set of REs. The communication manager 1006 may selectively monitor a PDCCH candidate, of the set of PDCCH candidates, in accordance with the first configuration information, second configuration information, and third configuration information. In some aspects, the communication manager 1006 may perform one or more operations described elsewhere herein as being performed by one or more components of the communication manager 1006.

The communication manager 1006 may receive or may cause the reception component 1002 to receive first configuration information identifying a configuration for a set of candidate SSBs associated with a first set of resource elements (REs). The communication manager 1006 may receive or may cause the reception component 1002 to monitor a PDCCH associated with scheduling a PDSCH in a second set of REs wherein at least one first RE, of the first set of REs, overlaps with at least one second RE, of the second set of REs, corresponding to a PDCCH candidate of the set of PDCCH candidates. The communication manager 1006 may receive or may cause the reception component 1002 to selectively receive the PDSCH in the at least one second RE in connection with a collision rule for the overlap between the at least one first RE and the at least one second RE. In some aspects, the communication manager 1006 may perform one or more operations described elsewhere herein as being performed by one or more components of the communication manager 1006.

In some aspects, the communication manager 1006 includes a set of components, such as an identification component 1010, or a prioritization component 1012. Alternatively, the set of components may be separate and distinct from the communication manager 1006. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1002 may receive first configuration information identifying a configuration for a set of candidate SSBs associated with a first set of REs. The reception component 1002 may receive second configuration information identifying a second set of REs for a set of PDCCH candidates. The reception component 1002 may receive third configuration information identifying one or more SSBs, of the set of candidate SSBs, that are transmitted in the first set of REs. The reception component 1002 may selectively monitor a PDCCH candidate, of the set of PDCCH candidates, in accordance with the first configuration information, second configuration information, and third configuration information. The reception component 1002 may monitor the PDCCH candidate, wherein the PDCCH candidate is associated with scheduling a PDSCH.

The reception component 1002 may receive first configuration information identifying a configuration for a set of candidate SSBs associated with a first set of REs. The reception component 1002 may monitor a PDCCH associated with scheduling a PDSCH in a second set of REs wherein at least one first RE, of the first set of REs, overlaps with at least one second RE, of the second set of REs, corresponding to a PDCCH candidate of the set of PDCCH candidates. The reception component 1002 may selectively receive the PDSCH in the at least one second RE in connection with a collision rule for the overlap between the at least one first RE and the at least one second RE.

The identification component 1010 may identify the overlap between the at least one first RE and the at least one second RE. The prioritization component 1012 may determine which communication to prioritize for reception in connection with a collision rule or an identification of an overlap. The reception component 1002 may receive third configuration information identifying one or more SSBs, of the set of candidate SSBs, that are transmitted in the first set of REs, wherein the at least one first RE is for an SSB, of the one or more SSBs, that is transmitted. The reception component 1002 may receive third configuration information identifying a burst periodicity indication of the set of candidate SSBs, and wherein the at least one first RE is for an SSB, of the set of candidate SSBs, that is transmitted in accordance with the burst periodicity indication.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports downlink channel communication with OD-SSB transmission. The apparatus 1100 may be a network node, or a network node may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 145). In some aspects, the communication manager 1106 is the communication manager 155

In some aspects, the apparatus 1100 may be configured to or operable to perform one or more operations described herein in connection with FIGS. 4A-5. Additionally or alternatively, the apparatus 1100 may be configured to or operable to perform one or more processes described herein, such as process 800 of FIG. 8, or process 900 of FIG. 9.

The reception component 1102 may receive communications, such as reference signals, control information, or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the network node described above in connection with FIG. 1, such as a radio, one or more RF chains, one or more transceivers, or one or more modems, each of which may in turn be coupled with one or more antennas of the network node.

The transmission component 1104 may transmit communications, such as reference signals, control information, or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node. In some aspects, the transmission component 1104 may be co-located with the reception component 1102.

The communication manager 1106 may transmit or may cause the transmission component 1104 to transmit first configuration information identifying a configuration for a set of candidate SSBs associated with a first set of REs. The communication manager 1106 may transmit or may cause the transmission component 1104 to transmit second configuration information identifying a second set of REs for a set of PDCCH candidates. The communication manager 1106 may transmit or may cause the transmission component 1104 to transmit third configuration information identifying one or more SSBs, of the set of candidate SSBs, that are transmitted in the first set of REs. The communication manager 1106 may transmit or may cause the transmission component 1104 to selectively transmit a PDCCH candidate, of the set of PDCCH candidates, in accordance with the first configuration information, second configuration information, and third configuration information. In some aspects, the communication manager 1106 may perform one or more operations described elsewhere herein as being performed by one or more components of the communication manager 1106.

The communication manager 1106 may transmit or may cause the transmission component 1104 to transmit first configuration information identifying a configuration for a set of candidate SSBs associated with a first set of REs. The communication manager 1106 may transmit or may cause the transmission component 1104 to transmit a PDCCH associated with scheduling a PDSCH in a second set of REs wherein at least one first RE, of the first set of REs, overlaps with at least one second RE, of the second set of REs, corresponding to a PDCCH candidate of the set of PDCCH candidates. The communication manager 1106 may transmit or may cause the transmission component 1104 to selectively transmit the PDSCH in the at least one second RE in connection with a collision rule for the overlap between the at least one first RE and the at least one second RE. In some aspects, the communication manager 1106 may perform one or more operations described elsewhere herein as being performed by one or more components of the communication manager 1106.

In some aspects, the communication manager 1106 includes a set of components, such as a determination component 1110. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1104 may transmit first configuration information identifying a configuration for a set of candidate SSBs associated with a first set of REs. The transmission component 1104 may transmit second configuration information identifying a second set of REs for a set of PDCCH candidates. The transmission component 1104 may transmit third configuration information identifying one or more SSBs, of the set of candidate SSBs, that are transmitted in the first set of REs. The transmission component 1104 may selectively transmit a PDCCH candidate, of the set of PDCCH candidates, in accordance with the first configuration information, second configuration information, and third configuration information. The transmission component 1104 may transmit the PDCCH candidate, wherein the PDCCH candidate is associated with scheduling a PDSCH.

The transmission component 1104 may transmit first configuration information identifying a configuration for a set of candidate SSBs associated with a first set of REs. The transmission component 1104 may transmit a PDCCH associated with scheduling a PDSCH in a second set of REs wherein at least one first RE, of the first set of REs, overlaps with at least one second RE, of the second set of REs, corresponding to a PDCCH candidate of the set of PDCCH candidates. The transmission component 1104 may selectively transmit the PDSCH in the at least one second RE in connection with a collision rule for the overlap between the at least one first RE and the at least one second RE.

The transmission component 1104 may transmit third configuration information identifying one or more SSBs, of the set of candidate SSBs, that are transmitted in the first set of REs, wherein the at least one first RE is for an SSB, of the one or more SSBs, that is transmitted. The transmission component 1104 may transmit third configuration information identifying a burst periodicity indication of the set of candidate SSBs, and wherein the at least one first RE is for an SSB, of the set of candidate SSBs, that is transmitted in accordance with the burst periodicity indication. The determination component 1110 may determine whether a UE is to receive an SSB, a PDCCH, or a PDSCH in a particular RE, and may configure communication accordingly.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

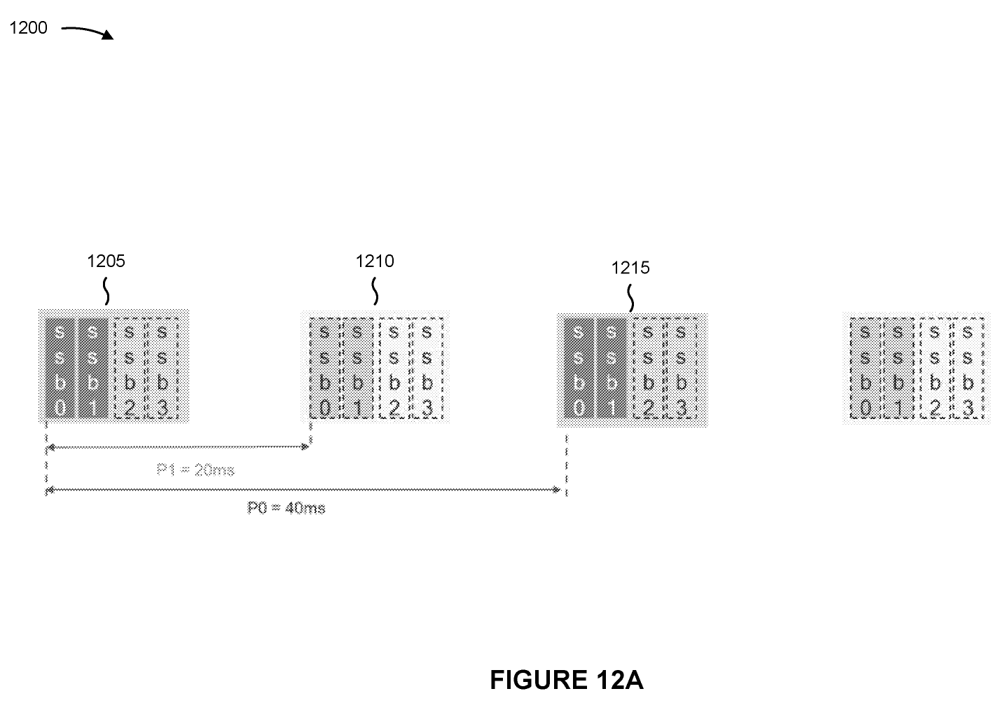

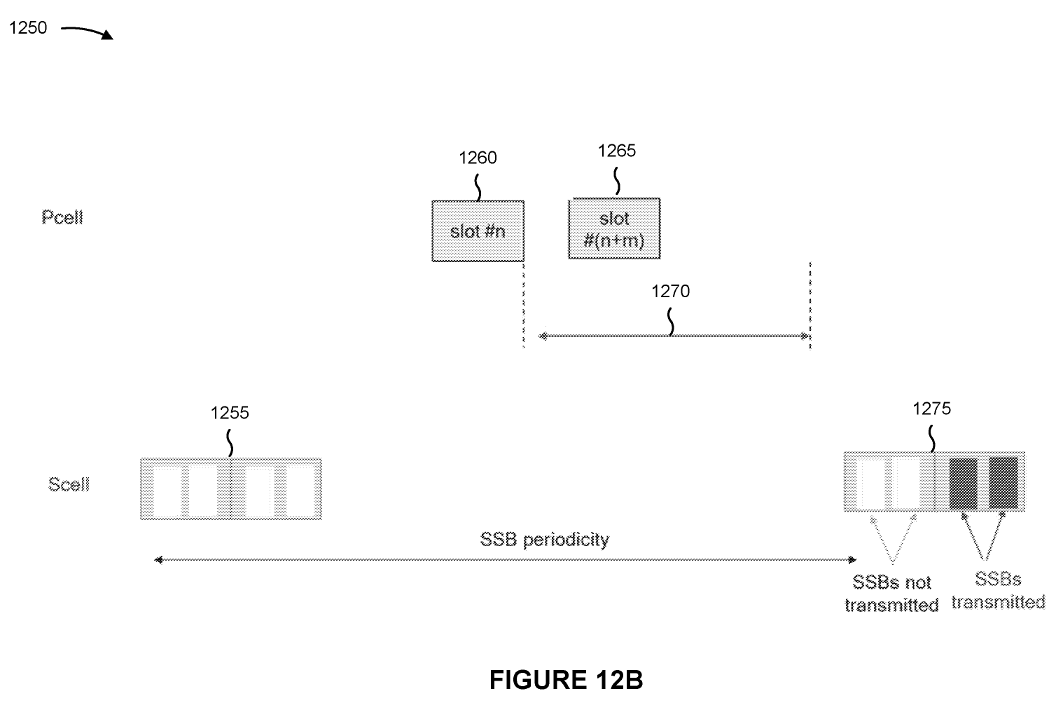

FIGS. 12A-12B are diagrams illustrating examples of SSB burst communications.

As shown in FIG. 12A, in example 1200, AO-SSB transmission and OD-SSB transmission may have respective a periodic time domain patterns. When a union of AO-SSB transmission and OD-SSB transmission has a periodic time domain pattern of a 5 millisecond (ms) periodicity, the AO-SSB transmission and the OD-SSB transmission may have different half-frame indices. In contrast, if the union of the AO-SSB transmission and the OD-SSB transmission has a periodic time domain pattern with a higher periodicity (for example, 10 ms, 20 ms, 40 ms, 80 ms, or 160 ms), the AO-SSB transmission and the OD-SSB transmission may have a common half-frame index. When center frequency locations of the AO-SSB and OD-SSB transmissions are different, the AO-SSB and OD-SSB transmissions may have a PBCH payload with the same SSB index. Furthermore, when frequency locations of the AO-SSB and OD-SSB transmissions are the same, time domain locations of an AO-SSB burst is a subset of time domain locations of an OD-SSB burst. For example, a first SSB burst 1205 is a fully overlapped AO-SSB burst and OD-SSB burst. In this example, the AO-SSB bursts have a periodicity P0 of 40ms and the OD-SSB bursts have a periodicity P1 of 20 ms. Accordingly, a second SSB burst 1210 is an OD-SSB burst without an AO-SSB burst overlapping and a third SSB burst 1215 is an OD-SSB burst with a fully overlapped AO-SSB burst.

A network node, such as the network node 110, can use a MAC-CE to indicate an OD-SSB to be transmitted and a periodicity of the OD-SSB. As shown in FIG. 12B, and in example 1250, the network node may configure, on an Scell, a candidate SSB burst 1255 with up to 4 SSBs, such as via RRC signaling. On the Pcell, the network node may transmit, in a slot n, an OD-SSB indication 1260, such as via MAC-CE signaling, configuring (for example, activating or deactivating) OD-SSB transmission in configured SSB bursts corresponding to the candidate SSB burst 1255. A UE may transmit a physical uplink control channel (PUCCH) communication 1265, in a slot n + m provide HARQ ACK feedback for the OD-SSB indication 1260. The PUCCH communication 1265 may indicate that the UE acknowledges the OD-SSB transmission in a next transmission opportunity at least a configured period of time 1270 after transmission of the OD-SSB indication 1260. Accordingly, in an SSB burst 1275, SSBs may be transmitted in some transmission opportunities, but not in other transmission opportunities, as shown and in accordance with the OD-SSB indication 1260.

The following provides an overview of some Aspects of the present disclosure:

Aspect 1: A method of wireless communication performed by a user equipment (UE), comprising: receiving first configuration information identifying a configuration for a set of candidate synchronization signal / physical broadcast channel block (SSBs) associated with a first set of resource elements (REs); receiving second configuration information identifying a second set of REs for a set of physical downlink control channel (PDCCH) candidates; receiving third configuration information identifying one or more SSBs, of the set of candidate SSBs, that are transmitted in the first set of REs; and selectively monitoring a PDCCH candidate, of the set of PDCCH candidates, in accordance with the first configuration information, second configuration information, and third configuration information.

Aspect 2: The method of Aspect 1, wherein the third configuration information is conveyed via at least one of: radio resource control signaling, medium access control (MAC) control element signaling, or downlink control information signaling.

Aspect 3: The method of any of Aspects 1-2, wherein the first configuration information includes an indication of an SSB index for a serving cell, and wherein at least one first RE of the first set of REs corresponds to an SSB block index included in the first configuration information.

Aspect 4: The method of any of Aspects 1-3, wherein the set of PDCCH candidates are not associated with a type-0 PDCCH common search space set.

Aspect 5: The method of any of Aspects 1-4, wherein at least one first RE, of the first set of REs, overlaps with at least one second RE, of the second set of REs, corresponding to a PDCCH candidate of the set of PDCCH candidates; and wherein selectively monitoring the PDCCH candidate comprises: forgoing monitoring the PDCCH candidate in connection with the overlap between the at least one first RE and the at least one second RE.

Aspect 6: The method of any of Aspects 1-5, comprising: monitoring the PDCCH candidate, wherein at least one second RE of the PDCCH does not overlap with at least one first RE of the one or more SSBs that are transmitted in accordance with the third configuration information.

Aspect 7: The method of Aspect 6, comprising: monitoring the PDCCH candidate, wherein the PDCCH candidate is associated with scheduling a physical downlink shared channel (PDSCH).

Aspect 8: The method of Aspect 7, wherein a resource allocation for the PDSCH overlaps with one or more physical resource blocks (PRBs) that provide a transmission resource for an SSB of the one or more SSBs that are transmitted in accordance with the third configuration information, and wherein the one or more PRBs are not available for the PDSCH.

Aspect 9: The method of Aspect 8, wherein the PDSCH and the SSB are associated with a common physical cell identity.

Aspect 10: The method of any of Aspects 1-9, wherein the third configuration information includes information identifying a burst periodicity indication of the set of candidate SSBs, and wherein at least one first RE, of the first set of REs, is for an SSB, of the set of candidate SSBs, that is transmitted in accordance with the third configuration information.

Aspect 11: The method of Aspect 10, wherein the first configuration information includes an indication of an SSB index for a serving cell, and wherein the at least one first RE, of the SSB, corresponds to an SSB block index included in the first configuration information.

Aspect 12: The method of Aspect 10, wherein the set of PDCCH candidates are not associated with a type-0 PDCCH common search space set.

Aspect 13: The method of Aspect 10, comprising: monitoring the PDCCH candidate, wherein the PDCCH candidate is associated with scheduling a physical downlink shared channel (PDSCH).

Aspect 14: The method of Aspect 13, wherein a resource allocation for the PDSCH overlaps with one or more physical resource blocks (PRBs) that provide a transmission resource for the SSB that is transmitted in accordance with the burst periodicity indication in the third configuration information, and wherein the one or more PRBs are not available for the PDSCH.

Aspect 15: The method of Aspect 14, wherein the PDSCH and the SSB are associated with a common physical cell identity.

Aspect 16: A method of wireless communication performed by a user equipment (UE), comprising: receiving first configuration information identifying a configuration for a set of candidate synchronization signal / physical broadcast channel block (SSBs) associated with a first set of resource elements (REs); receiving a physical downlink control channel (PDCCH) associated with scheduling a physical downlink shared channel (PDSCH) in a second set of REs, wherein at least one first RE, of the first set of REs, overlaps with at least one second RE, of the second set of REs, corresponding to a PDCCH candidate of the set of PDCCH candidates; and selectively receiving the PDSCH in the at least one second RE in connection with a collision rule for the overlap between the at least one first RE and the at least one second RE.

Aspect 17: The method of Aspect 16, comprising: receiving third configuration information identifying one or more SSBs, of the set of candidate SSBs, that are transmitted in the first set of REs, wherein the at least one first RE is for an SSB, of the one or more SSBs, that is transmitted.

Aspect 18: The method of Aspect 17, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively receiving the PDSCH comprises: receiving the PDSCH, wherein a resource allocation for the PDSCH does not overlap with one or more physical resource blocks (PRBs) that provide a transmission resource for the one or more SSBs that are transmitted in accordance with the third configuration information.

Aspect 19: The method of Aspect 17, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively receiving the PDSCH comprises: receiving the PDSCH, wherein a resource allocation for the PDSCH overlaps with one or more physical resource blocks (PRBs) that provide a transmission resource for the one or more SSBs that is transmitted in accordance with the third configuration information, and wherein the one or more PRBs are not available for the PDSCH.

Aspect 20: The method of Aspect 17, wherein the PDCCH is associated with a cyclic redundancy check (CRC) that is scrambled with a system information radio network temporary identifier for at least one of: another system information, a paging RNTI, a random access RNTI, a random access message B RNTI, or a temporary cell RNTI; and wherein selectively receiving the PDSCH comprises: forgoing receiving the PDSCH.

Aspect 21: The method of any of Aspects 16-20, comprising: receiving third configuration information identifying a burst periodicity indication of the set of candidate SSBs, and wherein the at least one first RE is for an SSB, of the set of candidate SSBs, that is transmitted in accordance with the burst periodicity indication.

Aspect 22: The method of Aspect 21, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively receiving the PDSCH comprises: receiving the PDSCH, wherein a resource allocation for the PDSCH does not overlap with one or more physical resource blocks (PRBs) that provide a transmission resource for the one or more SSBs that are transmitted in accordance with the third configuration information.

Aspect 23: The method of Aspect 21, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively receiving the PDSCH comprises: receiving the PDSCH, wherein a resource allocation for the PDSCH overlaps with one or more physical resource blocks (PRBs) that provide a transmission resource for the one or more SSBs that is transmitted in accordance with the third configuration information, and wherein the one or more PRBs are not available for the PDSCH.

Aspect 24: The method of Aspect 21, wherein the PDCCH is associated with a cyclic redundancy check (CRC) that is scrambled with a system information radio network temporary identifier for at least one of: another system information, a paging RNTI, a random access RNTI, a random access message B RNTI, or a temporary cell RNTI; and wherein selectively receiving the PDSCH comprises: forgoing receiving the PDSCH.

Aspect 25: A method of wireless communication performed by a network node, comprising: transmitting first configuration information identifying a configuration for a set of candidate synchronization signal / physical broadcast channel block (SSBs) associated with a first set of resource elements (REs); transmitting second configuration information identifying a second set of REs for a set of physical downlink control channel (PDCCH) candidates; transmitting third configuration information identifying one or more SSBs, of the set of candidate SSBs, that are transmitted in the first set of REs; and selectively transmitting a PDCCH candidate, of the set of PDCCH candidates, in accordance with the first configuration information, second configuration information, and third configuration information.

Aspect 26: The method of Aspect 25, wherein the third configuration information is conveyed via at least one of: radio resource control signaling, medium access control (MAC) control element signaling, or downlink control information signaling.

Aspect 27: The method of any of Aspects 25-26, wherein the first configuration information includes an indication of an SSB index for a serving cell, and wherein at least one first RE of the first set of REs corresponds to an SSB block index included in the first configuration information.

Aspect 28: The method of any of Aspects 25-27, wherein the set of PDCCH candidates are not associated with a type-0 PDCCH common search space set.

Aspect 29: The method of any of Aspects 25-28, wherein at least one first RE, of the first set of REs, overlaps with at least one second RE, of the second set of REs, corresponding to a PDCCH candidate of the set of PDCCH candidates; and wherein selectively transmitting the PDCCH candidate comprises: forgoing transmitting the PDCCH candidate in connection with the overlap between the at least one first RE and the at least one second RE.

Aspect 30: The method of any of Aspects 25-29, comprising: transmitting the PDCCH candidate, wherein at least one second RE of the PDCCH does not overlap with at least one first RE of the one or more SSBs that are transmitted in accordance with the third configuration information.

Aspect 31: The method of any of Aspects 25-30, comprising: transmitting the PDCCH candidate, wherein the PDCCH candidate is associated with scheduling a physical downlink shared channel (PDSCH).

Aspect 32: The method of Aspect 31, wherein a resource allocation for the PDSCH overlaps with one or more physical resource blocks (PRBs) that provide a transmission resource for an SSB of the one or more SSBs that are transmitted in accordance with the third configuration information, and wherein the one or more PRBs are not available for the PDSCH.

Aspect 33: The method of Aspect 32, wherein the PDSCH and the SSB are associated with a common physical cell identity.

Aspect 34: The method of any of Aspects 25-33, wherein the third configuration information includes information identifying a burst periodicity indication of the set of candidate SSBs, and wherein at least one first RE, of the first set of REs, is for an SSB, of the set of candidate SSBs, that is transmitted in accordance with the third configuration information.

Aspect 35: The method of Aspect 34, wherein the first configuration information includes an indication of an SSB index for a serving cell, and wherein the at least one first RE, of the SSB, corresponds to an SSB block index included in the first configuration information.

Aspect 36: The method of Aspect 34, wherein the set of PDCCH candidates are not associated with a type-0 PDCCH common search space set.

Aspect 37: The method of Aspect 34, comprising: transmitting the PDCCH candidate, wherein the PDCCH candidate is associated with scheduling a physical downlink shared channel (PDSCH).

Aspect 38: The method of Aspect 37, wherein a resource allocation for the PDSCH overlaps with one or more physical resource blocks (PRBs) that provide a transmission resource for the SSB that is transmitted in accordance with the burst periodicity indication in the third configuration information, and wherein the one or more PRBs are not available for the PDSCH.

Aspect 39: The method of Aspect 38, wherein the PDSCH and the SSB are associated with a common physical cell identity.

Aspect 40: A method of wireless communication performed by a network node, comprising: transmitting first configuration information identifying a configuration for a set of candidate synchronization signal / physical broadcast channel block (SSBs) associated with a first set of resource elements (REs); transmitting a physical downlink control channel (PDCCH) associated with scheduling a physical downlink shared channel (PDSCH) in a second set of REs, wherein at least one first RE, of the first set of REs, overlaps with at least one second RE, of the second set of REs, corresponding to a PDCCH candidate of the set of PDCCH candidates; and selectively transmitting the PDSCH in the at least one second RE in connection with a collision rule for the overlap between the at least one first RE and the at least one second RE.

Aspect 41: The method of Aspect 40, comprising: transmitting third configuration information identifying one or more SSBs, of the set of candidate SSBs, that are transmitted in the first set of REs, wherein the at least one first RE is for an SSB, of the one or more SSBs, that is transmitted.

Aspect 42: The method of Aspect 41, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively transmitting the PDSCH comprises: transmitting the PDSCH, wherein a resource allocation for the PDSCH does not overlap with one or more physical resource blocks (PRBs) that provide a transmission resource for the one or more SSBs that are transmitted in accordance with the third configuration information.

Aspect 43: The method of Aspect 41, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively transmitting the PDSCH comprises: transmitting the PDSCH, wherein a resource allocation for the PDSCH overlaps with one or more physical resource blocks (PRBs) that provide a transmission resource for the one or more SSBs that is transmitted in accordance with the third configuration information, and wherein the one or more PRBs are not available for the PDSCH.

Aspect 44: The method of Aspect 41, wherein the PDCCH is associated with a cyclic redundancy check (CRC) that is scrambled with a system information radio network temporary identifier for at least one of: another system information, a paging RNTI, a random access RNTI, a random access message B RNTI, or a temporary cell RNTI; and wherein selectively transmitting the PDSCH comprises: forgoing transmitting the PDSCH.

Aspect 45: The method of any of Aspects 40-44, comprising: transmitting third configuration information identifying a burst periodicity indication of the set of candidate SSBs, and wherein the at least one first RE is for an SSB, of the set of candidate SSBs, that is transmitted in accordance with the burst periodicity indication.

Aspect 46: The method of Aspect 45, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively transmitting the PDSCH comprises: transmitting the PDSCH, wherein a resource allocation for the PDSCH does not overlap with one or more physical resource blocks (PRBs) that provide a transmission resource for the one or more SSBs that are transmitted in accordance with the third configuration information.

Aspect 47: The method of Aspect 45, wherein the PDCCH is associated with a cyclic redundancy check (CRC) that is scrambled with at least one of: a system information radio network temporary identifier (RNTI), a random access RNTI, a random access message B RNTI, a paging RNTI, or a temporary cell RNTI; and wherein selectively transmitting the PDSCH comprises: transmitting the PDSCH, wherein a resource allocation for the PDSCH overlaps with one or more physical resource blocks (PRBs) that provide a transmission resource for the one or more SSBs that is transmitted in accordance with the third configuration information, and wherein the one or more PRBs are not available for the PDSCH.

Aspect 48: The method of Aspect 45, wherein the PDCCH is associated with a cyclic redundancy check (CRC) that is scrambled with a system information radio network temporary identifier for at least one of: another system information, a paging RNTI, a random access RNTI, a random access message B RNTI, or a temporary cell RNTI; and comprising: forgoing transmitting the PDSCH.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

Aspect 56: A device comprising a processing system that includes one or more processors and one or more code-storing memories coupled with the one or more processors, the processing system configured to cause the device to perform the method of one or more of Aspects 1-48.

Aspect 57: A device comprising a processing system that includes processor circuitry and code-storing memory circuitry, the processing system configured to cause the device to perform the method of one or more of Aspects 1-48.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more antennas; and
a processing system that includes one or more processors and one or more memories, the processing system configured to cause the UE to:
wirelessly receive first configuration information identifying a configuration for a set of candidate synchronization signal / physical broadcast channel block (SSBs) associated with a first set of resource elements (REs);
wirelessly receive second configuration information identifying a second set of REs for a set of physical downlink control channel (PDCCH) candidates;
wirelessly receive third configuration information identifying one or more SSBs, of the set of candidate SSBs, that are transmitted in the first set of REs; and
selectively monitor, via a wireless link, a PDCCH candidate, of the set of PDCCH candidates, in accordance with the first configuration information, second configuration information, and third configuration information.

2. The apparatus of claim 1, wherein the third configuration information is conveyed via at least one of:
radio resource control signaling,
medium access control (MAC) control element signaling, or
downlink control information signaling.

3. The apparatus of claim 1, wherein the first configuration information includes an indication of an SSB index for a serving cell, and wherein at least one first RE of the first set of REs corresponds to an SSB block index included in the first configuration information.

4. The apparatus of claim 1, wherein the set of PDCCH candidates are not associated with a type-0 PDCCH common search space set.

5. The apparatus of claim 1, wherein at least one first RE, of the first set of REs, overlaps with at least one second RE, of the second set of REs, corresponding to a PDCCH candidate of the set of PDCCH candidates; and
wherein the processing system, to cause the UE to selectively monitor the PDCCH candidate, is configured to cause the UE to:
forgo monitoring the PDCCH candidate in connection with the overlap between the at least one first RE and the at least one second RE.

6. The apparatus of claim 1, wherein the processing system is configured to cause the UE to:
monitor the PDCCH candidate, wherein at least one second RE of the PDCCH does not overlap with at least one first RE of the one or more SSBs that are transmitted in accordance with the third configuration information.

7. The apparatus of claim 6, wherein the processing system is configured to cause the UE to:
receive a PDCCH communication in the PDCCH candidate, wherein the PDCCH is associated with scheduling a physical downlink shared channel (PDSCH).

8. The apparatus of claim 7, wherein a resource allocation for the PDSCH overlaps with one or more physical resource blocks (PRBs) that provide a transmission resource for an SSB of the one or more SSBs that are transmitted in accordance with the third configuration information, and wherein the one or more PRBs are not available for the PDSCH.

9. The apparatus of claim 8, wherein the PDSCH and the SSB are associated with a common physical cell identity.

10. The apparatus of claim 1, wherein the third configuration information includes information identifying a burst periodicity indication of the set of candidate SSBs, and wherein at least one first RE, of the first set of REs, is for an SSB, of the set of candidate SSBs, that is transmitted in accordance with the third configuration information.

11. The apparatus of claim 10, wherein the first configuration information includes an indication of an SSB index for a serving cell, and wherein the at least one first RE, of the SSB, corresponds to an SSB block index included in the first configuration information.

12. The apparatus of claim 10, wherein the set of PDCCH candidates are not associated with a type-0 PDCCH common search space set.

13. The apparatus of claim 10, wherein the processing system is configured to cause the UE to:
monitor the PDCCH candidate, wherein the PDCCH candidate is associated with scheduling a physical downlink shared channel (PDSCH).

14. The apparatus of claim 13, wherein a resource allocation for the PDSCH overlaps with one or more physical resource blocks (PRBs) that provide a transmission resource for the SSB that is transmitted in accordance with the burst periodicity indication in the third configuration information, and wherein the one or more PRBs are not available for the PDSCH.

15. The apparatus of claim 14, wherein the PDSCH and the SSB are associated with a common physical cell identity.

16. An apparatus for wireless communication at a user equipment (UE), comprising:
one or more antennas; and
a processing system that includes one or more processors and one or more memories, the processing system configured to cause the UE to:
wirelessly receive first configuration information identifying a configuration for a set of candidate synchronization signal / physical broadcast channel block (SSBs) associated with a first set of resource elements (REs);
wirelessly receive a physical downlink control channel (PDCCH) associated with scheduling a physical downlink shared channel (PDSCH) in a second set of REs,
wherein at least one first RE, of the first set of REs, overlaps with at least one second RE, of the second set of REs, corresponding to a PDCCH candidate of the set of PDCCH candidates; and
selectively wirelessly receive the PDSCH in the at least one second RE in connection with a collision rule for the overlap between the at least one first RE and the at least one second RE.

17. The apparatus of claim 16, wherein the processing system is configured to:
receive third configuration information identifying one or more SSBs, of the set of candidate SSBs, that are transmitted in the first set of REs, wherein the at least one first RE is for an SSB, of the one or more SSBs, that is transmitted.

18. The apparatus of claim 17, wherein the PDCCH is associated with a cyclic redundancy check (CRC) that is scrambled with at least one of:
a system information radio network temporary identifier (RNTI),
a random access RNTI,
a random access message B RNTI,
a paging RNTI, or
a temporary cell RNTI; and
wherein the processing system, to selectively receive the PDSCH, is configured to:
receive the PDSCH, wherein a resource allocation for the PDSCH does not overlap with one or more physical resource blocks (PRBs) that provide a transmission resource for the one or more SSBs that are transmitted in accordance with the third configuration information.

19. The apparatus of claim 17, wherein the PDCCH is associated with a cyclic redundancy check (CRC) that is scrambled with at least one of:
a system information radio network temporary identifier (RNTI),
a random access RNTI,
a random access message B RNTI,
a paging RNTI, or
a temporary cell RNTI; and
wherein the processing system, to cause the UE to selectively receive the PDSCH, is configured to cause the UE to:
receive the PDSCH, wherein a resource allocation for the PDSCH overlaps with one or more physical resource blocks (PRBs) that provide a transmission resource for the one or more SSBs that is transmitted in accordance with the third configuration information, and wherein the one or more PRBs are not available for the PDSCH.

20. An apparatus for wireless communication at a network node, comprising:
one or more antennas; and
a processing system that includes one or more processors and one or more memories, the processing system configured to cause the network node to:
wirelessly transmit first configuration information identifying a configuration for a set of candidate synchronization signal / physical broadcast channel block (SSBs) associated with a first set of resource elements (REs);
wirelessly transmit second configuration information identifying a second set of REs for a set of physical downlink control channel (PDCCH) candidates;
wirelessly transmit third configuration information identifying one or more SSBs, of the set of candidate SSBs, that are transmitted in the first set of REs; and
selectively wirelessly transmit a PDCCH candidate, of the set of PDCCH candidates, in accordance with the first configuration information, second configuration information, and third configuration information.
